(19) United States
(12) Patent Application Publication
(10) Pub. No.: US 2024/0267755 A1
(43) Pub. Date: Aug. 8, 2024

(54) NATIVE ARTIFICIAL INTELLIGENCE NETWORK ARCHITECTURE

(71) Applicant: Apple Inc., Cupertino, CA (US)

(72) Inventors: Peng Cheng, Beijing (CN); Haijing Hu, Los Gatos, CA (US); Onur Sahin, Highland, CA (US); Ralf Rossbach, Munich (DE); Sudeep Manithara Vamanan, Nuremberg (DE)

(73) Assignee: Apple Inc., Cupertino, CA (US)

(21) Appl. No.: 18/406,015

(22) Filed: Jan. 5, 2024

Related U.S. Application Data
(60) Provisional application No. 63/483,721, filed on Feb. 7, 2023.

(51) Int. Cl. H04W 24/02; H04B 7/06; H04W 28/06; H04W 76/20

(52) U.S. Cl. CPC H04W 24/02; H04B 7/0626; H04W 28/06; H04W 76/20

(57) ABSTRACT

The present application relates to devices and components including apparatus, systems, and methods to support native artificial intelligence model approaches in wireless communication systems.

### CROSS-REFERENCE TO RELATED APPLICATIONS

This application claims priority to U.S. provisional application No. 63/483,721, entitled “Native Artificial Intelligence Network Architecture,” filed on Feb. 7, 2023, the disclosure of which is incorporated by reference herein in its entirety for all purposes.

### TECHNICAL FIELD

The present application relates to the field of wireless technologies and, in particular, to native artificial intelligence network architecture.

### BACKGROUND

Third Generation Partnership Project (3GPP) networks utilize a radio access network (RAN) and a core network (CN) to provide services to user equipments (UEs). Each of the RAN and the CN have certain functions that provide the services to the UEs. The functions to be included in each of the RAN and the CN, generally, are standardized to serve legacy UEs.

### BRIEF DESCRIPTION OF THE DRAWINGS

FIG. 1 illustrates a portion of an example Open Radio Access Network (O-RAN) in accordance with some embodiments.

FIG. 2 illustrates an example of a network architecture supporting artificial intelligence (AI)/machine language (ML) in accordance with some embodiments.

FIG. 3 illustrates an example of a cloud framework in accordance with some embodiments.

FIG. 4 illustrates an example of a network arrangement in accordance with some embodiments.

FIG. 5 illustrates another example of a network arrangement in accordance with some embodiments.

FIG. 6 illustrates another example network arrangement in accordance with some embodiments.

FIG. 7 illustrates an example of services of a radio access network model repository function (RDRF) in accordance with some embodiments.

FIG. 8 illustrates an example of services of a radio access network data coordination function (RDCF) in accordance with some embodiments.

FIG. 9 illustrates an example of services of a radio access network model repository function (RMRF) in accordance with some embodiments.

FIG. 10 illustrates an example of services of a radio access network model coordination function (RMCF) in accordance with some embodiments.

FIG. 11 illustrates an example of services of a model repository function (MRF) in accordance with some embodiments.

FIG. 12 illustrates an example of services of a model coordination function (MCF) in accordance with some embodiments.

FIG. 13 illustrates an example of AI based channel state information (CSI) compression signaling in accordance with some embodiments.

FIG. 14 illustrates an example of AI based mobility signaling in accordance with some embodiments.

FIG. 15 illustrates an example procedure of operating a user equipment in accordance with some embodiments.

FIG. 16 illustrates an example procedure of operating a base station in accordance with some embodiments.

FIG. 17 illustrates a procedure that may be performed by a real-time AI function (RTAIF) structure or a non real-time AI function (NRTAIF) structure in accordance with some embodiments.

FIG. 18 illustrates an example user equipment (UE) in accordance with some embodiments.

FIG. 19 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “base station” as used herein may refer to a NodeB, an evolved NodeB, a next generation NodeB, or any other element that may perform the functions of a base station as known by one having ordinary skill in the art.

Network architecture and approaches described herein can provide support for artificial intelligence (AI)/machine language (ML) in a native manner. For example, the network architecture may have network functions (NFs) arranged to support near real-time AI and/or real-time AI. The architecture may further manage AI/ML models that can be utilized by UEs.

Some developments of radio access networks (RANs) are with respect to the following use cases: channel state information (CSI) feedback enhancement; beam management; and positioning accuracy enhancement. The network architectures described herein may support these use cases.

Three levels of user equipment (UE)/next generation NodeB (gNB) collaboration may be considered with respect to artificial intelligence (AI) models used in the RANs. In a first level (level x), there is no collaboration. In a second level (level y), signaling-based collaboration may occur without AI model transfer (e.g., assistance information for AI model selection). In a third level (level z), signaling-based collaboration may occur with model transfer. For example, the network architecture described herein may support signaling-based collaboration without model transfer and/or signaling-based collaboration with model transfer. Level x and level y may be the focus of RAN developments.

Key aspects are to define new reference signal, signaling/procedure to exchange AI model under lifecycle management (LCM). For example, approaches described herein may implement reference signals and/or signaling/procedures to exchange AI models.

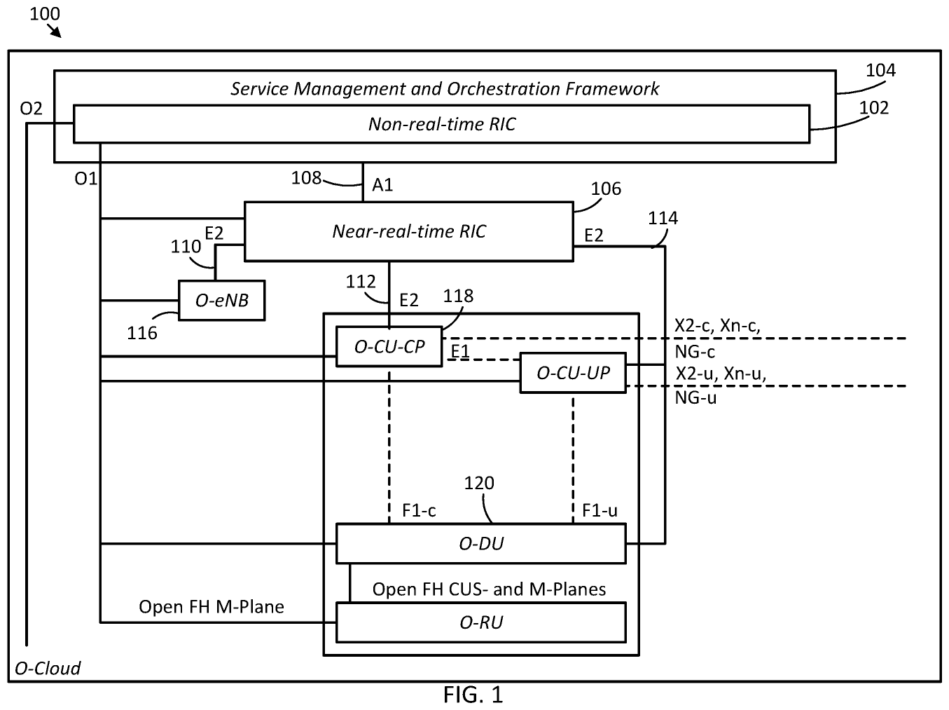

Approaches described herein may provide multi-vendor (such as for multiple UE and/or network (NW) vendors) AI model compatibility. There may be complexity in UE and gNB side operation due to a need to manage and use multiple AI models in parallel to support a range of different vendors at the collaboration node. For example, elements supported by the architectures described herein and/or the architectures described herein may implement different AI models. Different UEs may utilize different AI models that can be defined by the vendors of the UEs. The RAN and/or the CN of the architectures may support the different AI models that may be utilized by the UEs. The architectures may support may manage and use multiple AI models in parallel. Open Radio Access Network (O-RAN) is a totally disaggregated approach to deploying mobile fronthaul and midhaul networks built entirely on cloud native principles. FIG. 1 illustrates a portion of an example O-RAN 100 in accordance with some embodiments. The O-RAN 100 may support some AI/ML related elements, as described further below. Some AI/ML related features of the O-RAN 100 are described below.

The O-RAN 100 may include a non-real-time RAN intelligent controller (RIC) 102, which may be an AI/ML related element. The non-real-time RIC 102 may be part of a service management and orchestration framework 104. Optimization on a time scale>1 second (s). For example, the non-real-time RIC 102 may support optimization on a time scale of less than 1 s.

The O-RAN 100 may include a near-real-time RIC 106, which may be an AI/ML related element. Deployed in edge of network and optimization on a time scale between 10 milliseconds (ms) and 1 s. For example, the near-real-time RIC 106 may be deployed at an edge of the O-RAN 100. The near-real-time RIC 106 may support optimization on a time scale of between 10 ms and 1 s.

The O-RAN 100 may include a real-time RIC, which may be an AI/ML related element. In the illustrated embodiment, the O-RAN 100 may omit a real-time RIC. A real-time RIC may support an optimization of less than 10 ms.

The O-RAN 100 may include an A1 interface 108, which may be an AI/ML related element. The A1 interface 108 may be between non-real-time RIC 102 and near-real-time RIC 106. In particular, the A1 interface 108 may couple the non-real-time RIC 102 and the near-real-time RIC 106. The near-real-time RIC 106 may share its data with non-real-time RIC 102. For example, the near-real-time RIC 106 and the non-real-time RIC 102 may share data via the A1 interface 108.

The O-RAN 100 may include one or more E2 interfaces that allow applications with timescales less than one second (xAPPs) to be plugged in for RAN performance control. For example, the O-RAN 100 includes a first E2 interface 110, a second E2 interface 112, and a third E2 interface 114 in the illustrated embodiment. The first E2 interface 110 may couple the near-real-time RIC 106 with an O-RAN evolved NodeB (O-eNB) 116. The second E2 interface 112 may couple the near-real-time RIC 106 with an O-RAN central unit-control plane (O-CU-CP) 118. The third E2 interface 114 may couple the near-real-time RIC 106 with an O-RAN distributed unit (O-DU) 120.

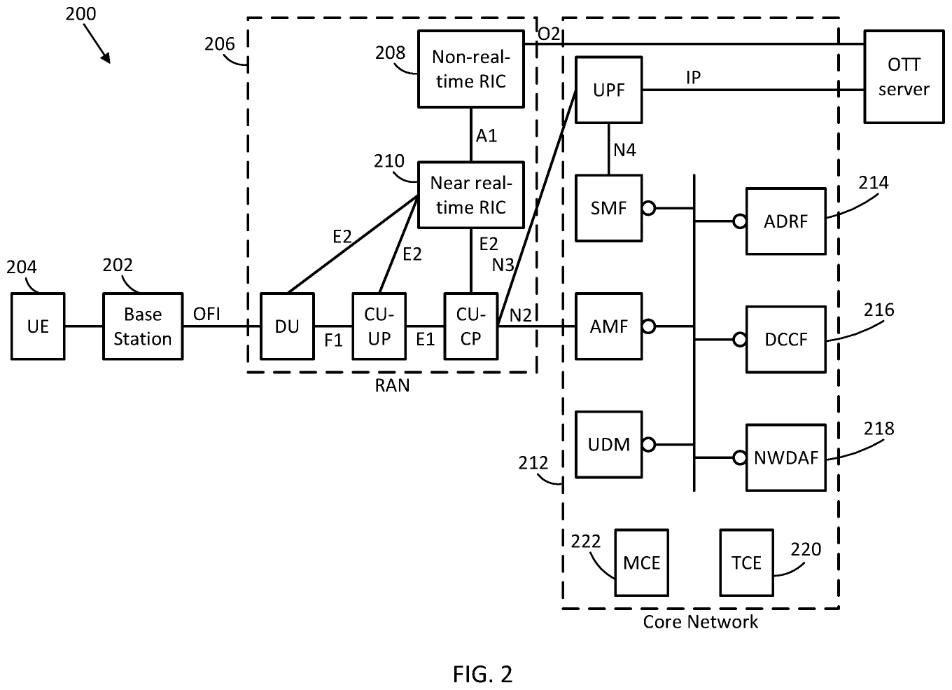

FIG. 2 illustrates an example of a network architecture 200 supporting AI/ML in accordance with some embodiments. For example, the network architecture 200 may be an example of a network architecture that supports AI/ML. The network architecture 200 may include an O-RAN, such as the O-RAN 100 (FIG. 1).

The network architecture 200 may include a base station 202 that can establish connections with one or more UEs, such as UE 204. The network architecture 200 may utilize the base station 202 to provide services to the one or more UEs.

The network architecture 200 may include a RAN 206. The RAN 206 may be coupled to the base station 202 and may manage the base station 202. The RAN 206 may include a non-real-time RIC 208 and a near real-time RIC 210. The non-real-time RIC 208 may include one or more of the features of the non-real-time RIC 102 (FIG. 1). The near real-time RIC 210 may include one or more of the features of the near-real-time RIC 106 (FIG. 1). The non-real-time RIC 208 and the near real-time RIC 320 may support AI/ML in the RAN 206 and may be referred to as RAN AI/ML blocks.

The network architecture 200 may include a core network (CN) 212. The core network 212 may be coupled to the RAN 206 and may support the RAN 206. The CN 212 may include one or more functions that serve the RAN 206. The CN 212 may include one or more elements that can support AI/ML. For example, the CN 212 may include an analytic data repository function (ADRF) 214 that can support AI/ML operation. The ADRF 214 may store data to support AI/ML. Further, the CN 212 may include a data collection coordination function (DCCF) 216 that can support AI/ML operation. The DCCF 216 may manage and/or coordinate data stored by the ADRF 214. The ADRF 214 and the DCCF 216 being located in the CN 212 can cause long latency for serving the RAN 206 and/or the base station 202. The long latency of the ADRF 214 and the DCCF 216 in the CN 212 may cause issues for elements that benefit from faster latency, such as the near real-time RIC 210 and real-time elements (such as real-time RICs).

The CN 212 may further include a network data analytics function (NWDAF) 218. The NWDAF 218 may collect data from core network functions, perform network analytics, and/or provide insights based on the collected data and/or network analysis. The operations performed by the NWDAF 218 may support AI/ML operation.

The CN 212 may further include a trace collection entity (TCE) 220. The TCE 220 may collect trace data and/or results and may store the trace data and/or results. The operations performed by the TCE 220 may support AI/ML operation.

The CN 212 may further include a multi-cell/multicast coordination entity (MCE) 222. The MCE 222 may manage and/or coordinate radio resources related to multimedia broadcast multicast service (MBMS). The MCE 22 may support AI/ML operation. Accordingly, the ADRF 214, the DCCF 216, the NWDAF 218, the TCE 220, and the MCE 222 of the CN 212 may support AI/ML operation and may be referred to as CN AI/ML blocks.

Sixth generation (6G) network architecture may be designed to support native AI. The native AI may have an air interface of a 6G network and network designs may leverage end-to-end (E2E) AI/ML to implement customized optimization and automated operations and maintenance (O&M). Further, the native AI may present evolution from centralized intelligence in the cloud to ubiquitous intelligence on deep edges. The native AI may support various time scales of AI/ML (e.g., Non-real-time, near real-time, real time).

The 6G network architecture may also be designed to have RAN-Core cloud native to the architecture. Having the RAN-Core cloud native may provide for simpler deployments whenever RAN and Core NFs can be co-located in the same cloud. The RAN and the Core Network can be converged.

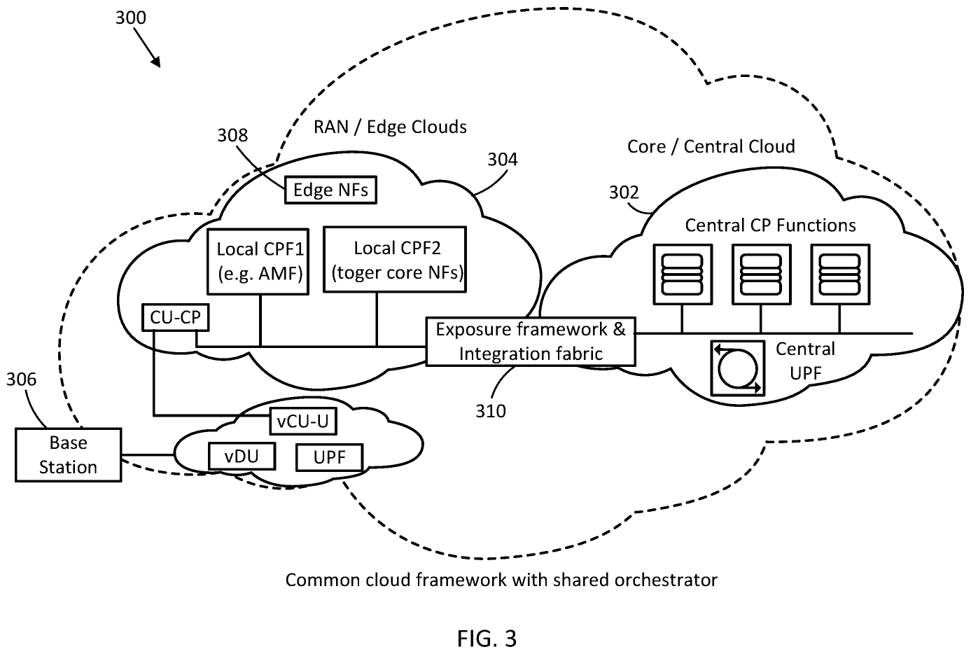

FIG. 3 illustrates an example of a cloud framework 300 in accordance with some embodiments. The cloud framework 300 may comprise a common cloud framework with a shared orchestrator.

The cloud framework 300 may include a core/central cloud 302. The core/central cloud 302 may provide central control plane (CP) functions and/or central user plane functions (UPFs). The core/central cloud 302 may provide CN functions for the network.

The cloud framework 300 may include one or more RAN/Edge clouds, such as the RAN/Edge cloud 304. The RAN/Edge cloud 304 may provide local functions for one or more base stations, such as base station 306. For example, the RAN/Edge cloud 304 may provide one or more edge NFs 308. The RAN/Edge cloud 304 may be coupled to the core/central cloud 302 via exposure framework and integration fabric 310.

The Fifth Generation (5G) network architecture may present issues for native AI/ML. Some issues of Fifth Generation (5G) network architecture for native AI/ML are described below.

For 5G network architecture, only near-real time (RT)-RIC and non-RT-RIC are specified by O-RAN. Further, for 5G network architecture, the fastest time scale of AI/ML is restricted to between 10 ms and 1 s. It is not sufficient for some on-line training (e.g., CSI compression). For example, legacy architectures may present latencies that are insufficient for high-speed operations, such as on-line training.

Network functions (NFs) for data repository are located in CN, which may not apply for near-RT-RIC or RT-RIC. For example, an analytics data repository function (ADRF) to store and retrieve the collected data and analytics is located in the CN in legacy architectures. Further, a data collection coordination function (DCCF) to manage/share the data collected in different NFs is located in the CN in legacy architectures. Long latency may be associated with retrieving data from ADRF. For example, the ADRF and/or the DCCF may be located in the CN in legacy architectures. The ADRF and/or the DCCF being located in the CN may cause the ADRF and/or the DCCF to have relatively long latencies. These long latencies may cause the ADRF and/or the DCCF located in the CN to be inadequate for elements with quick response times, such as near RT-RIC and/or RT-RIC.

There is no AI/ML model repository specified in legacy 5G networks. For NW-UE collaboration with model transfer (e.g., federated learning, transfer learning and meta learning), aligned AI/ML models between gNB and UE may be required. So, operator deployed AI/ML mode repository may be required for collaboration with model transfer (e.g., federated learning, transfer learning and meta learning). Similar to data repository, the latency caused by retrieving AI/ML model needs to be considered for near-RT-RIC or RT-RIC.

Embodiments of the present disclosure present a service-based architecture (SBA) based 6G network architecture with native AI supporting. Embodiments of the SBA based 6G network architecture presented herein may resolve the multi-vendor AI/ML model cooperation issue. Further, the 6G network architecture embodiments presented herein may introduce one or more new network functions (NFs) for unified management for AI/ML models for different Network and UE vendors. For example, architectures described throughout this disclosure may include an SBA with native AI support. The architectures may provide one or more functions for unified management of AI/ML models.

The SBA based 6G network architecture embodiments described herein with native AI support may increase efficiency of sharing collected data from different Network and UE vendors for model training. The SBA based 6G network architecture embodiments described herein may introduce a new NF (network function) for unified management for collected data for different gNB and UE vendors. For example, the architectures described throughout this disclosure may provide one or more functions for unified management for collected data. The one or more functions fur unified management for collected data may increase the efficiency of sharing collected data for model training.

Further, embodiments of the present disclosure may provide for better deployment of AI/ML inference entity in different time scales (e.g., Real time or Near real time). For example, the architectures described throughout this disclosure may provide for better deployment of AI/ML inference entity in different time scales.

Embodiments of the present disclosure may have control plane approaches and its signaling to enable 6G native AI/ML between Network and UE, with examples of CSI compression and mobility. For example, architectures described throughout this disclosure may present control plane approaches and/or signaling to enable native AI/ML.

Some embodiments provide a RAN SBA with data and model repository.

Embodiments of the present disclosure may introduce new RAN NFs in RAN SBA. For example, a RAN SBA, in accordance with some embodiments described herein, may include an RAN data repository function (RDRF) that can store and retrieve data collected from the RAN. Further, a RAN SBA, in accordance with some embodiments described herein, may include an RAN model repository function (RMRF) that can store and retrieve AI/ML models collected from RAN. The RMRF is deployed and managed by a mobile network operator (MNO), so NW and UE can have an aligned understanding on the used model which makes federated learning and transfer learning among different vendors possible.

An RAN SBA, in accordance with some embodiments described herein, may include an RAN data coordination function (RDCF) that can manage and/or share the data collected in different RAN and CN NFs. Further, a RAN SBA, in accordance with some embodiments described herein, may include an RAN model coordination function (RMCF) that can manage and/or share the models in different RAN and CN NFs. Non RT-RIC can also be included in RAN SBA because it has loose latency requirements.

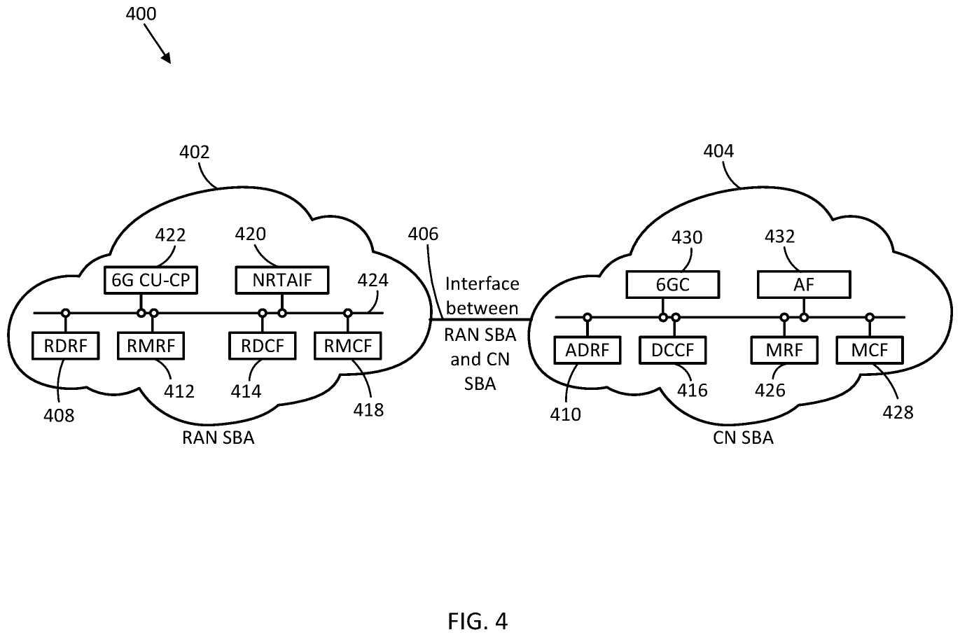

FIG. 4 illustrates an example of a network arrangement 400 in accordance with some embodiments. The network arrangement 400 may include a RAN 402 and a CN 404. The RAN 402 and the CN 404 may each have SBAs. The RAN 402 may be coupled to the CN 404 via an interface 406. The interface 406 may comprise a high speed interface.

The RAN 402 may include an RDRF 408. The RDRF 408 may store and/or retrieve data collected from the RAN 402. The RDRF 408 being located within the RAN 402 may cause the RDRF 408 to have lower latency relative to UEs and other elements in the RAN 402 than functions located within the CN 404. For example, the CN 404 may include an ADRF 410 that stores and retrieves collected data and analytics. The ADRF 410 may present a higher latency to UEs and elements in the RAN 402 than that of the RDRF 408 located in the RAN 402. The lower latency provided by the RDRF 408 may allow the RDRF 408 to serve real-time RICs and/or near real-time RICs without the latency issues presented by the ADRF 410 located within the CN 404.

The RAN 402 may further include an RMRF 412. The RMRF 412 may store and/or retrieve AI/ML models collected from the RAN 402. Accordingly, the RAN 402 may receive AI/ML models from UEs and/or base stations serviced by the RAN 402. The RMRF 412 may store the AI/ML models received by the RAN 402 and provide retrieval of the stored AI/ML models. The RMRF 412 being located in the RAN 402 may allow the RMRF 412 to present a latency adequate to serve real-time RICs and/or near real-time RICs.

The RMRF 412 being located within the RAN 402 may cause the RMRF 412 to have lower latency relative to UEs and other elements in the RAN 402 than functions located within the CN 404. For example, the CN 404 may include a model repository function (MRF) 426 that stores and retrieves models. The MRF 426 may present a higher latency to UEs and elements in the RAN 402 than that of the RMRF 412 located in the RAN 402. The lower latency provided by the RMRF 412 may allow the RMRF 412 to serve real-time RICs and/or near real-time RICs without the latency issues presented by the MRF 426 located in the CN 404.

The RAN 402 may further include an RDCF 414. The RDCF 414 may manage and/or share data collected in different RANs and/or CN NFs. The RDCF 414 being located within the RAN 402 may cause the RDCF 414 to have lower latency relative to UEs than functions located within the CN 404. For example, the CN 404 may include a DCCF 416 that manages and/or shares data collected in different NFs. The DCCF 416 may present a higher latency to UEs and/or base stations being by the RAN 402 and/or the CN 404 than that of the RDCF 414 located in the RAN 402. The lower latency provided by the RDCF 414 may allow the RDCF 414 to serve real-time RICs and/or near real-time RICs without the latency issues presented by the DCCF 416 located within the CN 404.

The RAN 402 may further include an RMCF 418. The RMCF 418 may manage and/or share the models in different RAN and/or CN NFs. Accordingly, the RAN 402 receive AI/ML models from UEs and/or base stations serviced by different RANs and/or CN NFs. The RMCF 418 may store the AI/ML models received from the different RANs and/or CN NFs and provide retrieval of the stored AI/ML models. The RMCF 418 being located in the RAN 402 may allow the RMCF 418 to present a latency adequate to serve real-time RICs and/or near real-time RICs.

The RMCF 418 being located within the RAN 402 may cause the RMCF 418 to have lower latency relative to UEs and other elements in the RAN 402 than functions located within the CN 404. For example, the CN 404 may include a model coordination function (MCF) 428 that manages and shares models. The MCF 428 may present a higher latency to UEs and elements in the RAN 402 than that of the RMCF 418 located in the RAN 402. The lower latency provided by the RMCF 418 may allow the RMCF 418 to serve real-time RICs and/or near real-time RICs without the latency issues presented by the MCF 428 located in the CN 404.

The RAN 402 may further include a non real-time AI function (NRTAIF) 420. The NRTAIF 420 may comprise a non RT-RIC and/or may provide the features provided by a non RT-RIC. The NRTAIF 420 may provide support for AI functions that can be performed in non-real-time.

The RAN 402 may further include a 6G central unit-control plane (CU-CP) element 422. The CU-CP element 422 may comprise a CU-CP function. The CU-CP element 422 may host a radio resource control (RRC) and/or a control plane part of a packet data convergence protocol (PDCP).

The RDRF 408, the RMRF 412, the RDCF 414, the RMCF 418, the NRTAIF 420, and/or the 6G CU-CP element 422 may be coupled in an SBA. For example, the RAN 402 include a bus 424 that couples the RDRF 408, the RMRF 412, the RDCF 414, the RMCF 418, the NRTAIF 420, and/or the 6G CU-CP element 422. The bus 424 may implement a hypertext transfer protocol (HTTP) interface, where HTTP may be utilized to address the RDRF 408, the RMRF 412, the RDCF 414, the RMCF 418, the NRTAIF 420, and/or the 6G CU-CP element 422 via the bus 424.

The CN 404 may further include a sixth generation core (6GC) 430. The 6GC 430 may provide functions provided by a core of a communications network as known by one having ordinary skill in the art. For example, the 6GC 430 may include a serving gateway (SGW), a packet data network gateway (PGW), a mobility management entity (MME), and/or a home subscriber server (HSS) in some embodiments.

The CN 404 may further include an application function (AF) 432. The AF 432 may provide functions provided by an AF of a communications network as known by one having ordinary skill in the art. For example, the AF 432 may manage application influence on traffic routing, may access a network exposure functions, and/or may interact with policy framework for policy control in some embodiments.

While the RAN 402 has been described with certain functions, it should be understood that the RAN 402 may include additional functions and/or have functions omitted in other embodiments. The additional functions may be coupled in the SBA and/or may be defined by hardware architecture.

Embodiments of the present disclosure may introduce a Real-Time AI function (RTAIF). Time scale for performing AI/ML inference is between 0.1 ms and 10 ms. For example, the time scale for performing AI/ML inference by the RTAIF may be between 0.1 ms and 10 ms. Sub-ms time scale is for on-device inference. It is connected to distributed unit (DU) via a new high-speed interface (e.g., E3) for edge deployment. For example, the RTAIF may be coupled to a distributed unit of a RAN via an E3 interface, where the E3 interface comprises a high-speed interface. It is connected to CU-CP in RAN SBA, which can coordinate data and model storage and management with CN SBA. For example, the RTAIF may be coupled to a CU-CP of a RAN. The CU-CP may coordinate data and model storage and management.

Near Real-Time AI function (NERTAIF) is connected to CU-CP and CU-UP. For example, the NERTAIF may be coupled to a CU-CP and/or a centralized unit-user plane (CU-UP) of a RAN.

Non Real-Time AI function (NRTAIF) is included in SBA RAN because it has no timing requirement. For example, the NRTAIF may be included in RAN having an SBA.

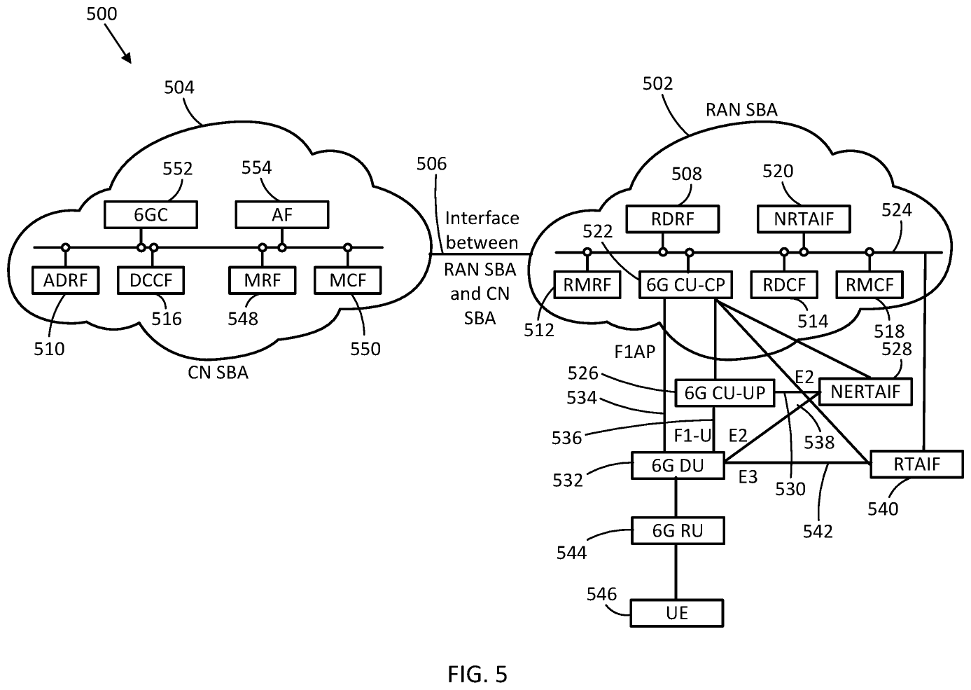

FIG. 5 illustrates another example of a network arrangement 500 in accordance with some embodiments. The network arrangement 500 may include a RAN 502 and a CN 504. The CN 504 may have an SBA. The RAN 502 may have a first portion that is SBA and a second portion that is hardware defined architecture. The RAN 502 may be coupled to the CN 504 via an interface 506. The interface 506 may comprise a high-speed interface.

The RAN 502 may include an RDRF 508. The RDRF 508 may include one or more of the features of the RDRF 408 (FIG. 4). The RDRF 508 may store and/or retrieve data collected from the RAN 502. The RDRF 508 being located within the RAN 502 may cause the RDRF 508 to have lower latency relative to UEs than functions located within the CN 504. For example, the CN 504 may include an ADRF 510 that stores and retrieves collected data and analytics. The ADRF 510 may present a higher latency to UEs and/or base stations being serviced by the RAN 502 and/or the CN 504 than that of the RDRF 508 located in the RAN 502. The lower latency provided by the RDRF 508 may allow the RDRF 508 to serve real-time RICs and/or near real-time RICs without the latency issues presented by the ADRF 510 located within the CN 504.

The RAN 502 may further include an RMRF 512. The RMRF 512 may include one or more of the features of the RMRF 412 (FIG. 4). The RMRF 512 may store and/or retrieve AI/ML models collected from the RAN 502. Accordingly, the RAN 502 may receive AI/ML models from UEs and/or base stations serviced by the RAN 502. The RMRF 512 may store the AI/ML models received by the RAN 502 and provide retrieval of the stored AI/ML models. The RMRF 512 being located in the RAN 502 may allow the RMRF 512 to present a latency adequate to serve real-time RICs and/or near real-time RICs.

The RMRF 512 being located within the RAN 502 may cause the RMRF 512 to have lower latency relative to UEs and other elements in the RAN 502 than functions located within the CN 504. For example, the CN 504 may include an MRF 548 that stores and retrieves models. The MRF 548 may present a higher latency to UEs and elements in the RAN 502 than that of the RMRF 512 located in the RAN 502. The lower latency provided by the RMRF 512 may allow the RMRF 512 to serve real-time RICs and/or near real-time RICs without the latency issues presented by the MRF 548 located in the CN 504.

The RAN 502 may further include an RDCF 514. The RDCF 514 may include one or more of the features of the RDCF 414 (FIG. 4) The RDCF 514 may manage and/or share data collected in different RANs and/or CN NFs. The RDCF 514 being located within the RAN 502 may cause the RDCF 514 to have lower latency relative to UEs than functions located within the CN 504. For example, the CN 504 may include a DCCF 516 that manages and/or shares data collected in different NFs. The DCCF 516 may present a higher latency to UEs and/or base stations being by the RAN 502 and/or the CN 504 than that of the RDCF 514 located in the RAN 502. The lower latency provided by the RDCF 514 may allow the RDCF 514 to serve real-time RICs and/or near real-time RICs without the latency issues presented by the DCCF 516 located within the CN 504.

The RAN 502 may further include an RMCF 518. The RMCF 518 may include one or more of the features of the RMCF 418 (FIG. 4). The RMCF 518 may manage and/or share the models in different RAN and/or CN NFs. Accordingly, the RAN 502 receive AI/ML models from UEs and/or base stations serviced by different RANs and/or CN NFs. The RMCF 518 may store the AI/ML models received from the different RANs and/or CN NFs and provide retrieval of the stored AI/ML models. The RMCF 518 being located in the RAN 502 may allow the RMCF 518 to present a latency adequate to serve real-time RICs and/or near real-time RICs.

The RMCF 518 being located within the RAN 502 may cause the RMCF 518 to have lower latency relative to UEs and other elements in the RAN 502 than functions located within the CN 504. For example, the CN 504 may include an MCF 550 that manages and shares models. The MCF 550 may present a higher latency to UEs and elements in the RAN 502 than that of the RMCF 518 located in the RAN 502. The lower latency provided by the RMCF 518 may allow the RMCF 518 to serve real-time RICs and/or near real-time RICs without the latency issues presented by the MCF 550 located in the CN 504.

The RAN 502 may further include a non real-time AI function (NRTAIF) 520. The NRTAIF 520 may comprise a non RT-RIC and/or may provide the features provided by a non RT-RIC. The NRTAIF 520 may provide support for AI functions that can be performed in non-real-time.

The RAN 502 may further include a 6G central unit-control plane (CU-CP) element 522. The CU-CP element 522 may comprise a CU-CP function. The CU-CP element 522 may host a radio resource control (RRC) and/or a control plane part of a packet data convergence protocol (PDCP).

The RDRF 508, the RMRF 512, the RDCF 514, the RMCF 518, the NRTAIF 520, and/or the 6G CU-CP element 522 may be coupled in an SBA. For example, the RAN 502 include a bus 524 that couples the RDRF 508, the RMRF 512, the RDCF 514, the RMCF 518, the NRTAIF 520, and/or the 6G CU-CP element 522. The bus 524 may implement an HTTP interface, where HTTP may be utilized to address the RDRF 508, the RMRF 512, the RDCF 514, the RMCF 518, the NRTAIF 520, and/or the 6G CU-CP element 522 via the bus 524.

The RAN 502 may include a 6G CU-UP element 526. The 6G CU-UP element 526 may comprise a CU-UP function. The 6G CU-UP element 526 may host an RRC and/or a control-plane part of a PDCP protocol of the network arrangement 500. The 6G CU-UP element 526 may be coupled to the 6G CU-CP element 522. The 6G CU-UP element 526 may have a hardware connection to the 6G CU-CP element 522, thereby the 6G CU-UP element 526 being part of a hardware defined architecture of the RAN 502.

The RAN 502 may further include an NERTAIF 528. The NERTAIF 528 may comprise a near-real-time RIC and/or may provide the features provided by a near-real-time RIC. The NERTAIF 528 may be coupled to the 6G CU-CP element 522 and/or the 6G CU-UP element 526. The NERTAIF 528 may have an E2 interface 530 that connects the NERTAIF 528 to the 6G CU-UP element 526. The NERTAIF 528 may have a hardware connection to the 6G CU-CP element 522. Thereby, the NERTAIF 528 may be part of a hardware defined architecture of the RAN 502.

The RAN 502 may further include a 6G DU element 532. The 6G DU element 532 may be responsible for real-time L1 and/or L2 scheduling functions. The 6G DU element 532 may be coupled to the 6G CU-CP element 522, the 6G CU-UP element 526, and the NERTAIF 528. The 6G DU element 532 may have an F1 application protocol (F1AP) interface 534 that couples the 6G DU element 532 to the 6G CU-CP element 522. Further, the 6G DU element 532 may have an F1 user plane (F1-U) interface 536 that couples the 6G DU element 532 to the 6G CU-UP element 526. The 6G DU element 532 may further have an E2 interface 538 that couples the 6G DU element 532 to the NERTAIF 528. Thereby, the 6G DU element 532 may be part of a hardware defined architecture of the RAN 502.

The RAN 502 may further include an RTAIF 540. The RTAIF 540 may comprise a real-time RIC and/or may provide the features provided by a real-time RIC. The RTAIF 540 may be coupled to the bus 524, the 6G CU-CP element 522, and the 6G DU element 532. For example, the RTAIF 540 may be coupled to the bus 524 in an SBA. Further, the RTAIF 540 may have an E3 interface 542 that couples the RTAIF 540 to the 6G DU element 532. The E3 interface 542 may be a high-speed interface for edge deployment. The RTAIF 540 may further have a hardware connection to the 6G CU-CP element 522. Thereby, the RTAIF 540 may also be part of a hardware defined architecture of the RAN 502.

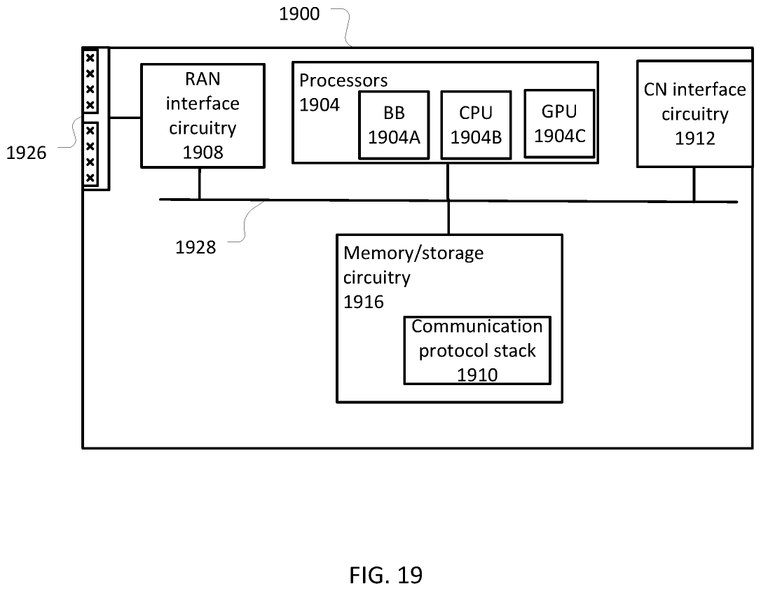

The RAN 502 may further include a 6G RU element 544. The 6G RU element 544 may include one or more of the features of the gNB 1900 (FIG. 19). The 6G RU element 544 may comprise a radio unit. The 6G RU element 544 may handle digital front end and/or parts of a physical layer of the RAN 502. The 6G RU element 544 may be coupled to the 6G DU element 532. The 6G RU element 544 may have a hardware connection to the 6G DU element 532. Thereby, the 6G RU element 544 may be part of the hardware defined architecture of the RAN 502.

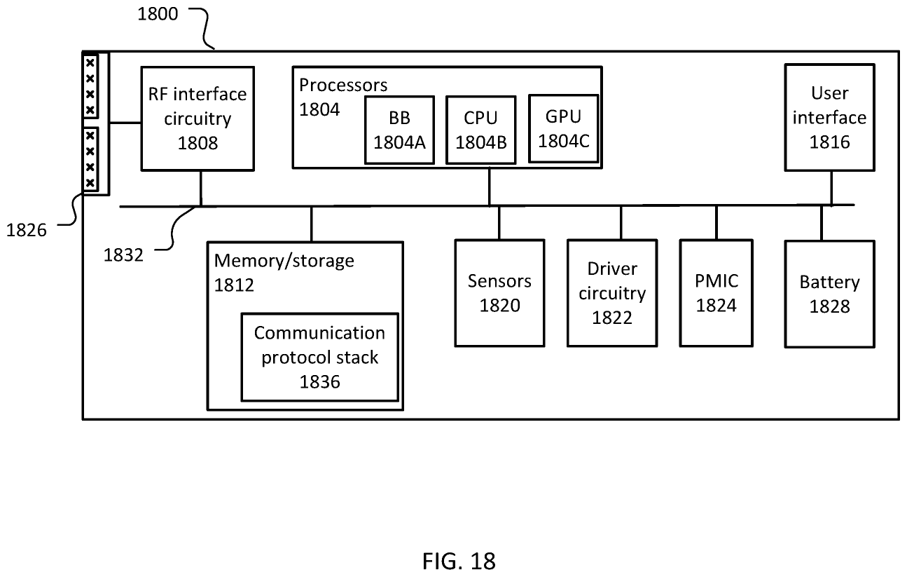

The network arrangement 500 may further comprise a UE 546. The UE 546 may include one or more of the features of the UE 1800 (FIG. 18). The UE 546 may establish a connection to the 6G RU element 544. The RAN 502 and/or the CN 504 may provide services to the UE 546 via the connection between the UE 546 and the 6G RU element 544.

The RDRF 508, the RMRF 512, the RDCF 514, and the RMCF 518 being located in the RAN 502 may present lower latency to other elements in the RAN 502 than the latencies of elements within the CN 504. For example, the RDRF 508, the RMRF 512, the RDCF 514, and the RMCF 518 may present lower latencies to other elements in the RAN 502 than the latencies provided by the ADRF 510 and the DCCF 516 located in the CN 504. These lower latencies presented by the RDRF 508, the RMRF 512, the RDCF 514, and the RMCF 518 may allow these elements to support other elements within the RAN 502 that require quick responses. For example, the low latencies of the RDRF 508, the RMRF 512, the RDCF 514, and the RMCF 518 may allow these elements to support the NERTAIF 528 and/or the RTAIF 540, whereas the higher latencies of the ADRF 510 and the DCCF 516 located within the CN 504 may cause issues with the response time required by the NERTAIF 528 and/or the RTAIF 540 for proper operation.

The CN 504 may further include a 6GC 552. The 6GC 552 may provide functions provided by a core of a communications network as known by one having ordinary skill in the art. For example, the 6GC 552 may include an SGW, a PGW, an MME, and/or an HSS in some embodiments.

The CN 504 may further include an AF 554. The AF 554 may provide functions provided by an AF of a communications network as known by one having ordinary skill in the art. For example, the AF 554 may manage application influence on traffic routing, may access a network exposure functions, and/or may interact with policy framework for policy control in some embodiments.

While the RAN 502 has been described with certain functions, it should be understood that the RAN 502 may include additional functions and/or have functions omitted in other embodiments. The additional functions may be coupled in the SBA and/or may be defined by hardware architecture.

Given that NFs of both RAN and CN are desired for operation of a network where we can have multiple levels of independent clouds, it is also conceivable that each SBA level of tiers/clouds can encompass a localized network with the full set of NFs (from both RAN and CN) in the same cloud. For example, a single cloud may include NFs of both the RAN and the CN of a network arrangement. The NFs, or at least some portion thereof, may be arrangement as an SBA.

In instances where a single cloud implements the NFs of both the RAN and the CN, one or more NFs from the RAN and the CN may be merged into a single NF in the cloud that can provide the services of the merged NFS. For example, a combined model repository function (CMRF) may be a merged RMRF and MRF. A combined data repository function (CDRF) may be a merged RDRF and ADRF. A combined model coordination function (CMCF) may be a merged RMCF and MCF. A combined data coordination function (CDCF) may be a merged RDCF and DCCF. The coordination functions can be used to manage/share information between different clouds.

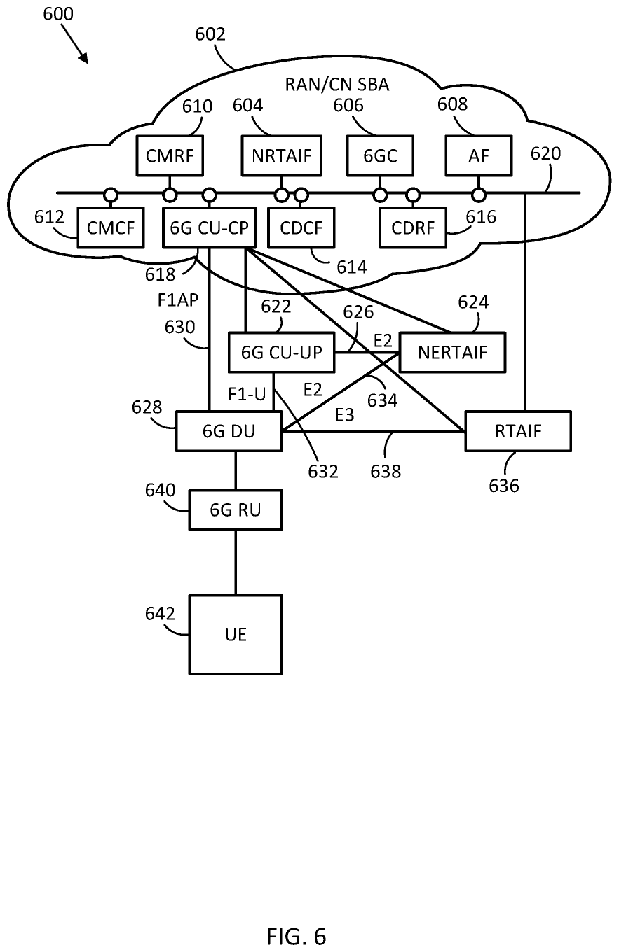

FIG. 6 illustrates another example network arrangement 600 in accordance with some embodiments. The network arrangement 600 illustrates one possible embodiment of a cloud that implements NFs of both RAN and CN of a network.

The network arrangement 600 may include a combined RAN/CN 602. The combined RAN/CN 602 may be implemented by a single cloud. The combined RAN/CN 602 may include features of a RAN and a CN, and/or may include features that combine features of the RAN and CN. At least a portion of the combined RAN/CN 602 may include an SBA.

The combined RAN/CN 602 may include an NRTAIF 604. The NRTAIF 604 may comprise a non RT-RIC and/or may provide the features provided by a non RT-RIC. The NRTAIF 604 may provide support for AI functions that can be performed in non-real-time.

The combined RAN/CN 602 may further include a sixth generation core (6GC) 606. The 6GC 606 may provide functions provided by a core of a communications network as known by one having ordinary skill in the art. For example, the 6GC 606 may include a serving gateway (SGW), a packet data network gateway (PGW), a mobility management entity (MME), and/or a home subscriber server (HSS) in some embodiments.

The combined RAN/CN 602 may further include an application function (AF) 608. The AF 608 may provide functions provided by an AF of a communications network as known by one having ordinary skill in the art. For example, the AF 608 may manage application influence on traffic routing, may access a network exposure functions, and/or may interact with policy framework for policy control in some embodiments.

The combined RAN/CN 602 may further include a CMRF 610. The CMRF 610 may comprise a merged RMRF and MRF element, and/or may provide the functions of an RMRF and an MRF. For example, the CMRF 610 may store and retrieve AI/ML models collected from RAN, and may manage real-time media processing.

The combined RAN/CN 602 may further include a CMCF 612. The CMCF 612 may comprise a merged RMCF and MCF element, and/or may provide the functions of an RMCF and an MCF. For example, the CMCF 612 may manage and/or share models in different RAN and/or CN NFs.

The combined RAN/CN 602 may further include a CDCF 614. The CDCF 614 may comprise a merged RDCF and DCCF element, and/or may provide the functions of an RDCF and a DCCF. For example, the CDCF 614 may manage and/or share data collected in different RANs and/or CN NFs, and/or may manage/share the data collected in different NFs.

The combined RAN/CN 602 may further include a CDRF 616. The CDRF 616 may comprise a merged RDRF and ADRF element, and/or may provide the functions of an RDRF and an ADRF. For example, the CDRF 616 may store and/or retrieve data collected from the combined RAN/CN 602, and/or may store and retrieve the collected data and analytics.

The combined RAN/CN 602 may further include a 6G CU-CP element 618. The CU-CP element 618 may comprise a CU-CP function. The CU-CP element 618 may host a radio resource control (RRC) and/or a control plane part of a packet data convergence protocol (PDCP).

The NRTAIF 604, the 6GC 606, the AF 608, the CMRF 610, the CMCF 612, the CDCF 614, the CDRF 616, and the 6G CU-CP element 618 may be coupled in an SBA. For example, the combined RAN/CN 602 include a bus 620 that couples the NRTAIF 604, the 6GC 606, the AF 608, the CMRF 610, the CMCF 612, the CDCF 614, the CDRF 616, and the 6G CU-CP element 618. The bus 620 may implement a hypertext transfer protocol (HTTP) interface, where HTTP may be utilized to address the NRTAIF 604, the 6GC 606, the AF 608, the CMRF 610, the CMCF 612, the CDCF 614, the CDRF 616, and the 6G CU-CP element 618 via the bus 620.

The combined RAN/CN 602 may include a 6G CU-UP element 622. The 6G CU-UP element 622 may comprise a CU-UP function. The 6G CU-UP element 622 may host an RRC and/or a control-plane part of a PDCP protocol of the network arrangement 600. The 6G CU-UP element 622 may be coupled to the 6G CU-CP element 618. The 6G CU-UP element 622 may have a hardware connection to the 6G CU-CP element 618, thereby the 6G CU-UP element 622 being part of a hardware defined architecture of the combined RAN/CN 602.

The combined RAN/CN 602 may further include an NERTAIF 624. The NERTAIF 624 may comprise a near-real-time RIC and/or may provide the features provided by a near-real-time RIC. The NERTAIF 624 may be coupled to the 6G CU-CP element 618 and/or the 6G CU-UP element 622. The NERTAIF 624 may have an E2 interface 626 that connects the NERTAIF 624 to the 6G CU-UP element 622. The NERTAIF 624 may have a hardware connection to the 6G CU-CP element 618. Thereby, the NERTAIF 624 may be part of a hardware defined architecture of the combined RAN/CN 602.

The combined RAN/CN 602 may further include a 6G DU element 628. The 6G DU element 628 may be responsible for real-time L1 and/or L2 scheduling functions. The 6G DU element 628 may be coupled to the 6G CU-CP element 618, the 6G CU-UP element 622, and the NERTAIF 624. The 6G DU element 628 may have an F1AP interface 630 that couples the 6G DU element 628 to the 6G CU-CP element 618. Further, the 6G DU element 628 may have an F1-U interface 632 that couples the 6G DU element 628 to the 6G CU-UP element 618.

The 6G DU element 628 may further have an E2 interface 634 that couples the 6G DU element 628 to the NERTAIF 624. Thereby, the 6G DU element 628 may be part of a hardware defined architecture of the combined RAN/CN 602.

The combined RAN/CN 602 may further include an RTAIF 636. The RTAIF 636 may comprise a real-time RIC and/or may provide the features provided by a real-time RIC. The RTAIF 636 may be coupled to the bus 620, the 6G CU-CP element 618, and the 6G DU element 628. For example, the RTAIF 636 may be coupled to the bus 620 in an SBA. Further, the RTAIF 636 may have an E3 interface 638 that couples the RTAIF 636 to the 6G DU element 628. The E3 interface 638 may be a high-speed interface for edge deployment. The RTAIF 636 may further have a hardware connection to the 6G CU-CP element 618. Thereby, the RTAIF 636 may also be part of a hardware defined architecture of the combined RAN/CN 602.

The combined RAN/CN 602 may further include a 6G RU element 640. The 6G RU element 640 may include one or more of the features of the gNB 1900 (FIG. 19). The 6G RU element 640 may comprise a radio unit. The 6G RU element 640 may handle digital front end and/or parts of a physical layer of the combined RAN/CN 602. The 6G RU element 640 may be coupled to the 6G DU element 628. The 6G RU element 640 may have a hardware connection to the 6G DU element 628. Thereby, the 6G RU element 640 may be part of the hardware defined architecture of the combined RAN/CN 602.

The network arrangement 600 may further comprise a UE 642. The UE 642 may include one or more of the features of the UE 1800 (FIG. 18). The UE 642 may establish a connection to the 6G RU element 640. The combined RAN/CN 602 may provide services to the UE 642 via the connection between the UE 642 and the 6G RU element 640.

The CMRF 610, the CMCF 612, the CDCF 614, and the CDRF 616 being located in the combined RAN/CN 602 may present lower latency than if the elements were located in a separate CN. These lower latencies presented by the CMRF 610, the CMCF 612, the CDCF 614, and the CDRF 616 may allow these elements to support other elements within the combined RAN/CN 602 that require quick responses. For example, the low latencies of the CMRF 610, the CMCF 612, the CDCF 614, and the CDRF 616 may allow these elements to support the NERTAIF 624 and/or the RTAIF 636.

The RDRF service may be used to store data or analytics in the RDRF, retrieve data or analytics from an RDRF, or delete data or analytics from an RDRF. The consumer can be RDCF, or another RDRF, DCCF or NRTAIF, RTAIF, NERTAIF. RDRF can request to store/retrieve data from ADRF in CN via RDCF/DCCF. RAN AI function (e.g., NRTAIF, RTAIF, NERTAIF) can retrieve data from RDRF. Each stored dataset has a unified dataset identifier (ID) which can be found in RDCF.

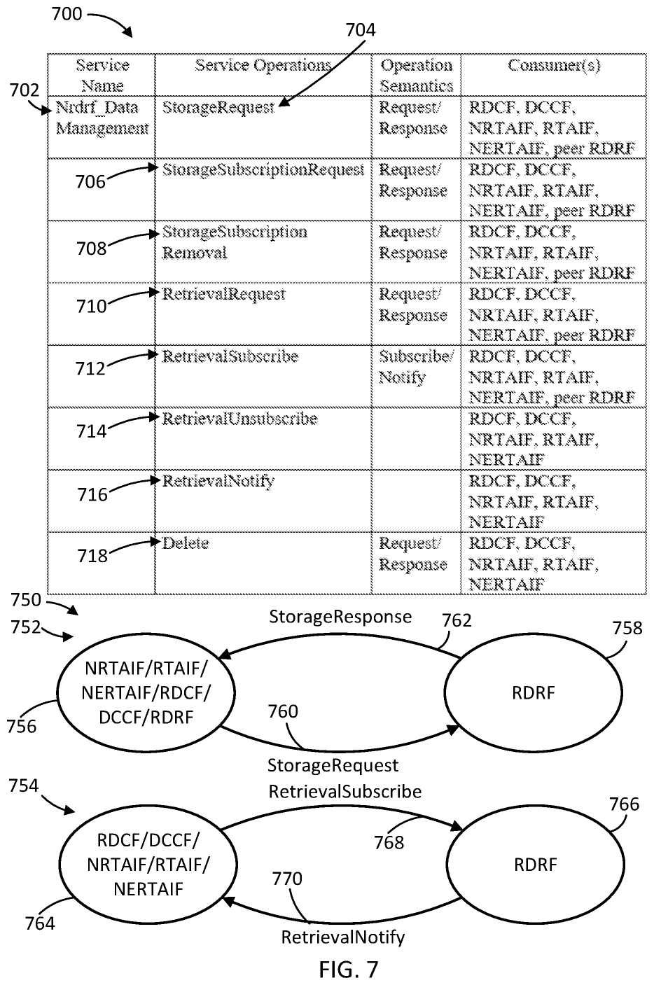

FIG. 7 illustrates an example of services of an RDRF in accordance with some embodiments. In particular, FIG. 7 illustrates a table 700 that shows services and service operations that may be performed with an RDRF. Further, FIG. 7 illustrates signaling diagrams 750 that illustrate signals that may be exchanged with an RDRF. The services and signaling illustrated by FIG. 7 may be performed by an RDRF (such as the RDRF 408 (FIG. 4) and/or the RDRF 508 (FIG. 5)) and/or a CDRF (such as the CDRF 616 (FIG. 6)). For brevity, the services and signaling are described as being performed by an RDRF, although it should be understood that the services and/or signaling may be performed by a CDRF in other embodiments.

As can be seen from the table 700, the RDRF may provide a service named Nrdrf_DataManagement 702. The Nrdrf_DataManagement 702 service provided by the RDRF may include storing and/or retrieving data collected from an RAN.

The RDRF may provide one or more service operations related to storage of data. For example, the RDRF may perform a storage/request (StorageRequest) operation 704. The StorageRequest operation 704 may include a consumer requesting the RDRF to store data and/or analytics and the RDRF storing the data and/or analytics. The StorageRequest operation 704 may utilize request and response signaling to perform the operation. The RDRF may perform the StorageRequest operation 704 with a consumer, such as an RDCF, a DCCF, an NRTAIF, an RTAIF, an NERTAIF, and/or another RDRF (which may be a peer RDRF).

The RDRF may further perform a storage/subscription/request (StorageSubscriptionRequest) operation 706. The StorageSubscriptionRequest operation 706 may include a consumer requesting that the RDRF initiate a subscription for data and/or analytics to receive and store the data and/or analytics. The StorageSubscriptionRequest operation 706 may utilize request and response signaling to perform the operation. The RDRF may perform the StorageSubscriptionRequest operation 706 with a consumer, such as an RDCF, a DCCF, an NRTAIF, an RTAIF, an NERTAIF, and/or another RDRF (which may be a peer RDRF).

The RDRF may further perform a storage/subscription/removal (StorageSubscriptionRemoval) operation 708. The StorageSubscriptionRemoval operation 708 may include a consumer requesting that the RDRF terminate a subscription for data and/or analytics that the RDRF has been receiving and storing. The StorageSubscriptionRemoval operation 708 may utilize request and response signaling to perform the operation. The RDRF may perform the StorageSubscriptionRemoval operation 708 with a consumer, such as an RDCF, a DCCF, an NRTAIF, an RTAIF, an NERTAIF, and/or another RDRF (which may be a peer RDRF).

The RDRF may further perform a retrieval/request (RetrievalRequest) operation 710. The RetrievalRequest operation 710 may include a consumer requesting the RDRF to retrieve data and/or analytics, and the RDRF providing the data and/or analytics to the consumer. The RetrievalRequest operation 710 may utilize request and response signaling to perform the operation. The RDRF may perform the RetrievalRequest operation 710 with a consumer, such as an RDCF, a DCCF, an NRTAIF, an RTAIF, an NERTAIF, and/or another RDRF (which may be a peer RDRF).

The RDRF may further perform a retrieval/subscribe (RetrievalSubscribe) operation 712. The RetrievalSubscribe operation 712 may include a consumer requesting stored data and/or analytics from the RDRF, and future notifications containing corresponding data and/or analytics received by the RDRF. The RDRF may provide the stored data and/or analytics and the future notifications to the consumer. The RetrievalSubscribe operation 712 may utilize subscribe and notify signaling to perform the operation. The RDRF may perform the RetrievalSubscribe operation 712 with a consumer, such as an RDCF, a DCCF, an NRTAIF, an RTAIF, an NERTAIF, and/or another RDRF (which may be a peer RDRF).

The RDRF may further perform a retrieval/unsubscribe (RetrievalUnsubscribe) operation 714. The RetrievalUnsubscribe operation 714 may include a consumer requesting that the RDRF terminate a subscription of the RDRF sending data and/or analytics to the consumer. The RDRF may perform the RetrievalUnsubscribe operation 714 with a consumer, such as an RDCF, a DCCF, an NRTAIF, an RTAIF, and/or an NERTAIF.

The RDRF may further perform a retrieval/notify (RetrievalNotify) operation 716. The RetrievalNotify operation 716 may include the RDRF providing data and/or analytics to the consumer, and/or providing instructions to the consumer to fetch the data and/or analytics from the RDRF. The RDRF may perform the RetrievalNotify operation 716 with a consumer, such as an RDCF, a DCCF, an NRTAIF, an RTAIF, and/or an NERTAIF.

The RDRF may further perform a delete operation 718. The delete operation 718 may include the RDRF deleting data stored by the RDRF. A consumer may request that the deletion of the data. The delete operation 718 may utilize request and response signaling to perform the operation. The RDRF may perform the delete operation 718 with a consumer, such as an RDCF, a DCCF, an NRTAIF, an RTAIF, and/or an NERTAIF.

The signaling diagrams 750 illustrate example signaling of the request and response signaling, and the subscribe and notify signaling of the service operations. In particular, the signaling diagrams 750 include a first diagram 752 that illustrates example request and response signaling. The signals illustrated in the request and response signaling of the first diagram 752 may be implemented for the service operations indicated as utilizing request and response signaling described above. The signaling diagrams 750 further include a second diagram 754 that illustrates example subscribe and notify signaling. The signals illustrated in the subscribe and notify signaling of the second diagram 754 may be implemented for the service operations indicated as utilizing subscribe and notify signaling described above.

The first diagram 752 illustrates example request and response signaling between a consumer 756 and an RDRF 758. The consumer 756 may comprise an NRTAIF, an RTAIF, an NERTAIF, an RDCF, a DCCF, and/or another RDRF. The consumer 756 may depend on the service operation being performed, as described above in accordance with the service operations.

The consumer 756 may transmit a storage/request (StorageRequest) message 760. The StorageRequest message 760 may indicate a service operation to be performed and data related to the service operation. For example, the StorageRequest message 760 may indicate data and/or analytics to be stored, and/or data and/or analytics to be retrieved. The consumer 756 may transmit the StorageRequest message 760 to the RDRF 758.

The RDRF 758 may receive the StorageRequest message 760 from the consumer 756. The RDRF 758 may perform the service operation as indicated by the StorageRequest message 760. The RDRF 758 may transmit a storage/response (StorageResponse) message 762 to the consumer 756. In the instance where the RDRF 758 performs the service operation, the StorageResponse message 762 may indicate that the service operation has been performed. In the instance where the RDRF 758 is unable to perform the service operation indicated by the StorageRequest message 760, the RDRF 758 may not perform the service operation and the StorageResponse message 762 may indicate that the RDRF 758 has not performed the service operation.

The second diagram 754 illustrates example subscribe and notify signaling between a consumer 764 and an RDRF 766. The consumer 764 may comprise an RDCF, a DCCF, an NRTAIF, an RTAIF, and/or an NERTAIF. The consumer 764 may depend on the service operation being performed, as described above in accordance with the service operations.

The consumer 764 may transmit a retrieval/subscribe (RetrievalSubscribe) message 768. The RetrievalSubscribe message 768 may indicate a service operation to be performed and data related to the service operation. For example, the RetrievalSubscribe message 768 may indicate data and/or analytics to be retrieved and/or for which notifications are to be provided. The consumer 764 may transmit the RetrievalSubscribe message 768 to the RDRF 766.

The RDRF 766 may receive the RetrievalSubscribe message 768 from the consumer 764. The RDRF 766 may perform the service operation as indicated by the RetrievalSubscribe message 768. The RDRF 766 may transmit a retrieval/notify (RetrievalNotify) message 770 to the consumer 764. In the instance where the RDRF 766 performs the service operation, the RetrievalNotify message 770 may indicate that the service operation has been performed. In the instance where the RDRF 766 is unable to perform the service operation indicated by the RetrievalSubscribe message 768, the RDRF 766 may not perform the service operation and the RetrievalNotify message 770 may indicate that the RDRF 766 has not performed the service operation.

While the table 700 indicates a particular service name and service operations, it should be understood that the service name and/or the service operations may be labeled differently in other instances. Further, while the signaling diagrams 750 illustrate certain signals to support the services, it should be understood that other signals may be transmitted between the subscriber and the RDRF to support the service operations in other embodiments.

The RDCF service can coordinate with other NFs to manage or coordinate the data or analytics in the RDRF. For data management service, the consumer can be NRTAIF, RTAIF, NERTAIF, RDRF, policy control function (PCF), AF, DCCF. For context management service, the consumer can be NRTAIF, RTAIF, NERTAIF, RDRF. Different from data management (e.g., retrieve dataset), the context management is for other NFs to identify the data or analytics in RDCF (e.g., retrieve dataset ID). All dataset IDs are stored and managed in RDCF. UE first finds RDCF via a network repository function (NRF), and then check suitable dataset ID via RDCF.

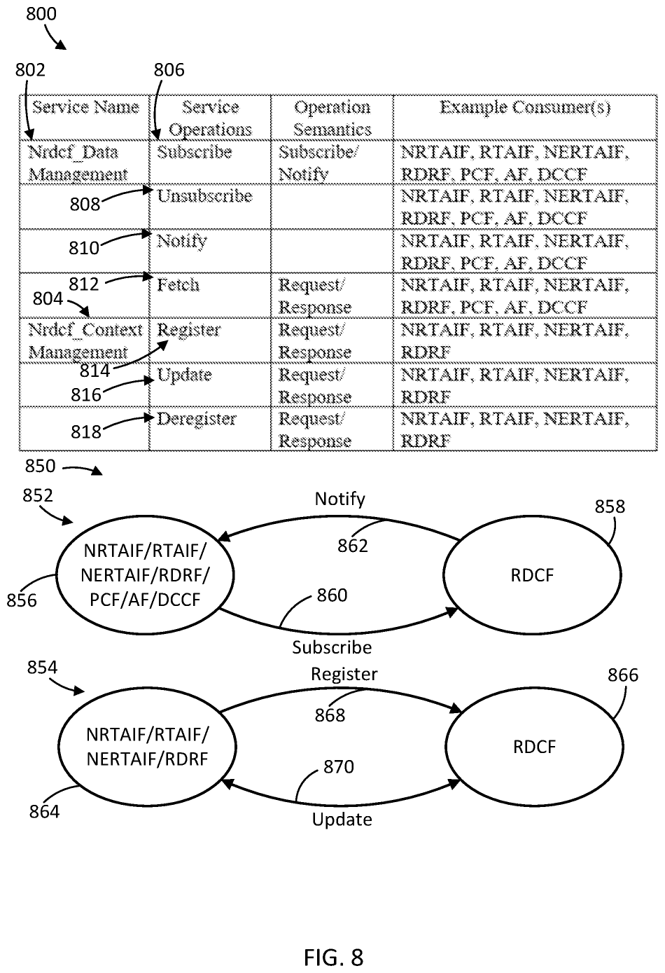

FIG. 8 illustrates an example of services of an RDCF in accordance with some embodiments. In particular, FIG. 8 illustrates a table 800 that shows services and service operations that may be performed with an RDCF. Further, FIG. 8 illustrates signaling diagrams 850 that illustrates signals that may be exchanged with an RDCF. The services and signaling illustrated by FIG. 8 may be performed by an RDCF (such as the RDCF 414 (FIG. 4) and/or the RDCF 514 (FIG. 5)) and/or a CDCF (such as the CDCF 614 (FIG. 6)). For brevity, the services and signaling are described as being performed by an RDCF, although it should be understood that the services and/or signaling may be performed by a CDCF in other embodiments.

As can be seen from the table 800, the RDCF may provide two services, a service named Nrdcf_DataManagement 802 and a service named Nrdcf_ContextManagement 804. The Nrdrf_DataManagement 802 service and/or the Nrdcf_ContextManagement 804 service provided by the RDCF may include managing and/or sharing data collected in different RANs and/or CN NFs. Each of the services may provide different service operations.

The RDCF may perform a subscribe operation 806. The subscribe operation 806 may include a consumer subscribing to data via the RDCF. The subscribe operation 806 may utilize subscribe and notify signaling to perform the operation. The RDCF may perform the subscribe operation 806 with a consumer, such as an NRTAIF, an RTAIF, an NERTAIF, an RDRF, a PCF, an AF, and/or a DCCF. The subscribe operation 806 may be performed as part of the Nrdcf_DataManagement 802 service.

The RDCF may further perform an unsubscribe operation 808. The unsubscribe operation 808 may include a consumer requesting termination of a subscription to data. The RDCF may perform the unsubscribe operation 808 with a consumer, such as an NRTAIF, an RTAIF, an NERTAIF, an RDRF, a PCF, an AF, and/or a DCCF. The unsubscribe operation 808 may be performed as part of the Nrdcf_DataManagement 802 service.

The RDCF may further perform a notify operation 810. The notify operation 810 may include the RDCF sending notification to endpoints corresponding to a subscription. The RDCF may process and format the data for the consumer and/or the endpoints. The RDCF may perform the notify operation 810 with a consumer, such as an NRTAIF, an RTAIF, an NERTAIF, an RDRF, a PCF, an AF, and/or a DCCF. The notify operation 810 may be performed as part of the Nrdcf_DataManagement 802 service.

The RDCF may further perform a fetch operation 812. The fetch operation 812 may include data being fetched from the RDCF. The fetch operation 812 may utilize request and response signaling to perform the operation. The RDCF may perform the fetch operation 812 with a consumer, such as an NRTAIF, an RTAIF, an NERTAIF, an RDRF, a PCF, an AF, and/or a DCCF. The fetch operation 812 may be performed as part of the Nrdcf_DataManagement 802 service.

The RDCF may further perform a register operation 814. The register operation 814 may include a consumer requesting registration with the RDCF and the RDCF registering the consumer. The register operation 814 may utilize request and response signaling to perform the operation. The RDCF may perform the register operation 814 with a consumer, such as an NRTAIF, an RTAIF, an NERTAIF, and/or an RDRF. The register operation 814 may be performed as part of the Nrdcf_ContextManagement 804 service.

The RDCF may further perform an update operation 816. The update operation 816 may include a consumer requesting update of registration data with the RDCF and the RDCF updating the registration data. The update operation 816 may utilize request and response signaling to perform the operation. The RDCF may perform the update operation 816 with a consumer, such as an NRTAIF, an RTAIF, an NERTAIF, and/or an RDRF. The update operation 816 may be performed as part of Nrdcf_ContextManagement 804 service.

The RDCF may further perform a deregister operation 818. The deregister operation 818 may include a consumer requesting deregistration with the RDCF and the RDCF deregistering the consumer. The deregister operation 818 may utilize request and response signaling to perform the operation. The RDCF may perform the deregister operation 818 with a consumer, such as an NRTAIF, an RTAIF, an NERTAIF, and/or an RDRF. The deregister operation 818 may be performed as part of Nrdcf_ContextManagement 804 service.

The signaling diagrams 850 illustrate example signaling of the notify and subscribe signaling, and the register and update signaling of the service operations. In particular, the signaling diagrams 850 include a first diagram 852 that illustrates example notify and subscribe signaling. The signals illustrated in the notify and subscribe signaling of the first diagram 852 may be implemented for the service operations indicated as utilizing subscribe and notify signaling described above. The signaling diagrams 850 further include a second diagram 854 that illustrates example register and update signaling. The signals illustrated in the register and update signaling of the second diagram 854 may be implemented for the service operations indicated as utilizing request and response signaling described above.

The first diagram 852 illustrates example notify and subscribe signaling between a consumer 856 and an RDCF 858. The consumer 856 may comprise an NRTAIF, an RTAIF, an NERTAIF, an RDRF, a PCF, an AF, and/or a DCCF. The consumer 856 may depend on the service operation being performed, as described above in accordance with the service operations.

The consumer 856 may transmit a subscribe message 860. The subscribe message 860 may indicate data and/or analytics from the RDCF to which the consumer 856 is requesting to subscribe. For example, the subscribe message 860 may indicate data and/or analytics to which the consumer 856 would like to subscribe. The consumer 856 may transmit the subscribe message 860 to the RDCF 858.

The RDCF 858 may receive the subscribe message 860 from the consumer 856.

The RDCF 858 may perform the service operation as indicated by the subscribe message 860. The RDCF 858 may transmit a notify message 862 to the consumer 856. In the instance where the RDCF 858 performs the service operation, the notify message 862 may indicate that the service operation has been performed. In the instance where the RDCF 858 is unable to perform the service operation indicated by the subscribe message 860, the RDCF 858 may not perform the service operation and the notify message 862 may indicate that the RDCF 858 has not performed the service operation.

The second diagram 854 illustrates example register and update signaling between a consumer 864 and an RDCF 866. The register and update signaling may be a form of request and response signaling, and may be utilized by the service operations that implement request and response signaling described above. The consumer 864 may comprise an NRTAIF, an RTAIF, an NERTAIF, and/or an RDRF. The consumer 864 may depend on the service operation being performed, as described above in accordance with the service operations.

The consumer 864 may transmit a register message 868. The register message 868 may indicate a service operation to be performed and data related to the service operation. For example, the register message 868 may indicate that the consumer 864 is to be registered with the RDCF 866 and/or data for registering the consumer 864 with the RDCF 866. The consumer 864 may transmit the register message 868 to the RDCF 866.

The RDCF 866 may receive the register message 868 from the consumer 864. The RDCF 866 may perform the service operation as indicated by the register message 868. The RDCF 866 may transmit an update message 870 to the consumer 864. In the instance where the RDCF 866 performs the service operation, the update message 870 may indicate that the service operation has been performed. In the instance where the RDCF 866 is unable to perform the service operation indicated by the register message 868, the RDCF 866 may not perform the service operation and the update message 870 may indicate that the RDCF 866 has not performed the service operation.

In other instances, the RDCF 866 may transmit the update message 870. The update message 870 may indicate an update to be made to the consumer 864. For example, the update message 870 may indicate that a configuration of the consumer 864 is to be updated. The RDCF 866 may transmit the update message 870 to the consumer 864.

The consumer 864 may receive the update message 870 from the RDCF 866. The consumer 864 may perform the service operation indicated by the update message 870. The consumer 864 may transmit the register message 868 to the RDCF 866. In the instance where the consumer 864 performs the service operation, the register message 868 may indicate that the service operation has been performed. In the instance where the consumer 864 is unable to perform the service operation indicated by the update message 870, the consumer 864 may not perform the service operation and the register message 868 may indicate that the consumer 864 has not performed the service operation.

While the table 800 indicates a particular service name and service operations, it should be understood that the service name and/or the service operations may be labeled differently in other instances. Further, while the signaling diagrams 850 illustrate certain signals to support the services, it should be understood that other signals may be transmitted between the subscriber and the RDCF to support the service operations in other embodiments.

RMRF service is used to store AI/ML model in the RMRF, retrieve AI/ML model from an RMRF, or delete AI/ML model from an RMRF. The consumer can be RMCF, or another RMRF, MCF or NRTAIF, RTAIF, NERTAIF. RMRF can request to store/retrieve model from MRF in CN via MCF/RMCF. RAN AI function (e.g., NRTAIF, RTAIF, NERTAIF) can retrieve model from RMRF. Each stored model has a unified model ID which can be found in RMCF.

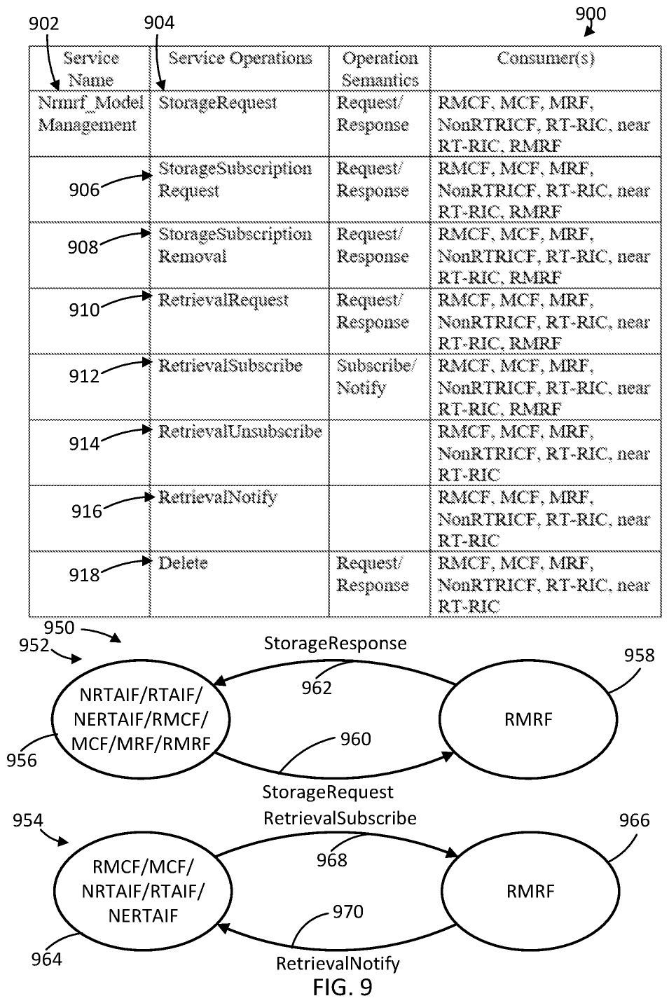

FIG. 9 illustrates an example of services of an RMRF in accordance with some embodiments. In particular, FIG. 9 illustrates a table 900 that shows services and service operations that may be performed with an RMRF. Further, FIG. 9 illustrates signaling diagrams 950 that illustrate signals that may be exchanged with an RMRF. The services and signaling illustrated by FIG. 9 may be performed by an RMRF (such as the RMRF 412 (FIG. 4) and/or the RMRF 512 (FIG. 5)) and/or a CMRF (such as the CMRF 610 (FIG. 6)). For brevity, the services and signaling are described as being performed by an RMRF, although it should be understood that the services and/or signaling may be performed by a CMRF in other embodiments.

As can be seen from the table 900, the RMRF may provide a service named Nrmrf_ModelManagement 902. The Nrmrf_ModelManagement 902 service provided by the RMRF may include storing and/or retrieving AI/ML models collected from an RAN.

The RMRF may provide one or more service operations related to storage of models. For example, the RMRF may perform a storage/request (StorageRequest) operation 904. The StorageRequest operation 904 may include a consumer requesting the RMRF to store one or more AI/ML models and the RMRF storing the models. The StorageRequest operation 904 may utilize request and response signaling to perform the operation. The RMRF may perform the StorageRequest operation 904 with a consumer, such as an RMCF, an MCF, an MRF, a non-real-time RIC function (NonRTRICF), an RT-RIC, a near RT-RIC, and/or another RMRF.

The RMRF may further perform a storage/subscription/request (StorageSubscriptionRequest) operation 906. The StorageSubscriptionRequest operation 906 may include a consumer requesting that the RMRF initiate a subscription for AI/ML models to receive and store the AI/ML models. The StorageSubscriptionRequest operation 906 may utilize request and response signaling to perform the operation. The RMRF may perform the StorageSubscriptionRequest operation 906 with a consumer, such as an RMCF, an MCF, an MRF, a NonRTRICF, an RT-RIC, a near RT-RIC, and/or another RMRF.

The RMRF may further perform a storage/subscription/removal (StorageSubscriptionRemoval) operation 908. The StorageSubscriptionRemoval operation 908 may include a consumer requesting that the RMRF terminate a subscription for AI/ML models that the RMRF has been receiving and storing. The StorageSubscriptionRemoval operation 908 may utilize request and response signaling to perform the operation. The RMRF may perform the StorageSubscriptionRemoval operation 908 with a consumer, such as an RMCF, an MCF, an MRF, a NonRTRICF, an RT-RIC, a near RT-RIC, and/or another RMRF.

The RMRF may further perform a retrieval/request (RetrievalRequest) operation 910. The RetrievalRequest operation 910 may include a consumer requesting the RMRF to retrieve AI/ML models and the RMRF providing the AI/ML models to the consumer. The RetrievalRequest operation 910 may utilize request and response signaling to perform the operation. The RMRF may perform the RetrievalRequest operation 910 with a consumer, such as an RMCF, an MCF, an MRF, a NonRTRICF, an RT-RIC, a near RT-RIC, and/or another RMRF.

The RMRF may further perform a retrieval/subscribe (RetrievalSubscribe) operation 912. The RetrievalSubscribe operation 912 may include a consumer requesting stored AI/ML models from the RMRF, and future notifications containing corresponding AI/ML models received by the RMRF. The RMRF may provide the AI/ML models and the future notifications to the consumer. The RetrievalSubscribe operation 912 may utilize subscribe and notify signaling to perform the operation. The RMRF may perform the RetrievalSubscribe operation 912 with a consumer, such as an RMCF, an MCF, an MRF, a NonRTRICF, an RT-RIC, a near RT-RIC, and/or another RMRF.

The RMRF may further perform a retrieval/unsubscribe (RetrievalUnsubscribe) operation 914. The RetrievalUnsubscribe operation 914 may include a consumer requesting that the RMRF terminate a subscription of the RMRF sending AI/ML models to the consumer. The RMRF may perform the RetrievalUnsubscribe operation 914 with a consumer, such as an RMCF, an MCF, an MRF, a NonRTRICF, an RT-RIC, and/or a near RT-RIC.

The RMRF may further perform a retrieval/notify (RetrievalNotify) operation 916. The RetrievalNotify operation 916 may include the RMRF providing AI/ML models to the consumer, and/or providing instructions to the consumer to fetch the AI/ML models from the RMRF. The RMRF may perform the RetrievalNotify operation 916 with a consumer, such as an RMCF, an MCF, an MRF, a NonRTRICF, an RT-RIC, and/or a near RT-RIC.

The RMRF may further perform a delete operation 918. The delete operation 918 may include the RMRF deleting one or more AI/ML models stored by the RMRF. A consumer may request that the deletion of the AI/ML models. The delete operation 918 may utilize request and response signaling to perform the operation. The RMRF may perform the delete operation 918 with a consumer, such as an RMCF, an MCF, an MRF, a NonRTRICF, an RT-RIC, and/or a near RT-RIC.

The signaling diagrams 950 illustrate example signaling of the request and response signaling, and the subscribe and notify signaling of the service operations. In particular, the signaling diagrams 950 include a first diagram 952 that illustrates example request and response signaling. The signals illustrated in the request and response signaling of the first diagram 952 may be implemented for the service operations indicated as utilizing request and response signaling described above. The signaling diagrams 950 further include a second diagram 954 that illustrates example subscribe and notify signaling. The signals illustrated in the subscribe and notify signaling of the second diagram 954 may be implemented for the service operations indicated as utilizing subscribe and notify signaling described above.

The first diagram 952 illustrates example request and response signaling between a consumer 956 and an RMRF 958. The consumer 956 may comprise an RMCF, an MCF, an MRF, a NonRTRICF, an RT-RIC, a near RT-RIC, and/or another RMRF. The consumer 956 may depend on the service operation being performed, as described above in accordance with the service operations.

The consumer 956 may transmit a storage/request (StorageRequest) message 960. The StorageRequest message 960 may indicate a service operation to be performed and data related to the service operation. For example, the StorageRequest message 960 may indicate one or more AI/ML models to be stored, and/or one or more AI/ML models to be retrieved. The consumer 956 may transmit the StorageRequest message 960 to the RMRF 958.

The RMRF 958 may receive the StorageRequest message 960 from the consumer 956. The RMRF 958 may perform the service operation as indicated by the StorageRequest message 960. The RMRF 958 may transmit a StorageResponse message 962 to the consumer 956. In the instance where the RMRF 958 performs the service operation, the StorageResponse message 962 may indicate that the service operation has been performed. In the instance where the RMRF 958 is unable to perform the service operation indicated by the StorageRequest message 960, the RMRF 958 may not perform the service operation and the StorageResponse message 962 may indicate that the RMRF 958 has not performed the service operation.

The second diagram 954 illustrates example subscribe and notify signaling between a consumer 964 and an RMRF 966. The consumer 964 may comprise an RMCF, an MCF, an NRTAIF, an RTAIF, and/or an NERTAIF. The consumer 964 may depend on the service operation being performed, as described above in accordance with the service operations.

The consumer 964 may transmit a retrieval/subscribe (RetrievalSubscribe) message 968. The RetrievalSubscribe message 968 may indicate a service operation to be performed and data related to the service operation. For example, the RetrievalSubscribe message 968 may indicate AI/ML models to be retrieved and/or for which notifications are to be provided. The consumer 964 may transmit the RetrievalSubscribe message 968 to the RMRF 966.

The RMRF 966 may receive the RetrievalSubscribe message 968 from the consumer 964. The RMRF 966 may perform the service operation as indicated by the RetrievalSubscribe message 968. The RMRF 966 may transmit a retrieval/notify (RetrievalNotify) message 970 to the consumer 964. In the instance where the RMRF 966 performs the service operation, the RetrievalNotify message 970 may indicate that the service operation has been performed. In the instance where the RMRF 966 is unable to perform the service operation indicated by the RetrievalSubscribe message 968, the RMRF 966 may not perform the service operation and the RetrievalNotify message 970 may indicate that the RMRF 966 has not performed the service operation.

While the table 900 indicates a particular service name and service operations, it should be understood that the service name and/or the service operations may be labeled differently in other instances. Further, while the signaling diagrams 950 illustrate certain signals to support the services, it should be understood that other signals may be transmitted between the subscriber and the RMRF to support the service operations in other embodiments.

The RMCF service can coordinate with other NFs to manage or coordinate the AI/ML model in the RDRF. For model management service, the consumer can be NRTAIF, RTAIF, NERTAIF, RDRF, PCF, AF, MCF. For context management service, the consumer can be NRTAIF, RTAIF, NERTAIF, RMRF. Different from data management (e.g., retrieve model), the context management is for other NFs to identify the data or analytics in RMCF (e.g., retrieve model ID). All model IDs are stored and managed in RMCF. UE first finds RMCF via NRF, and then check suitable model ID via RMCF.

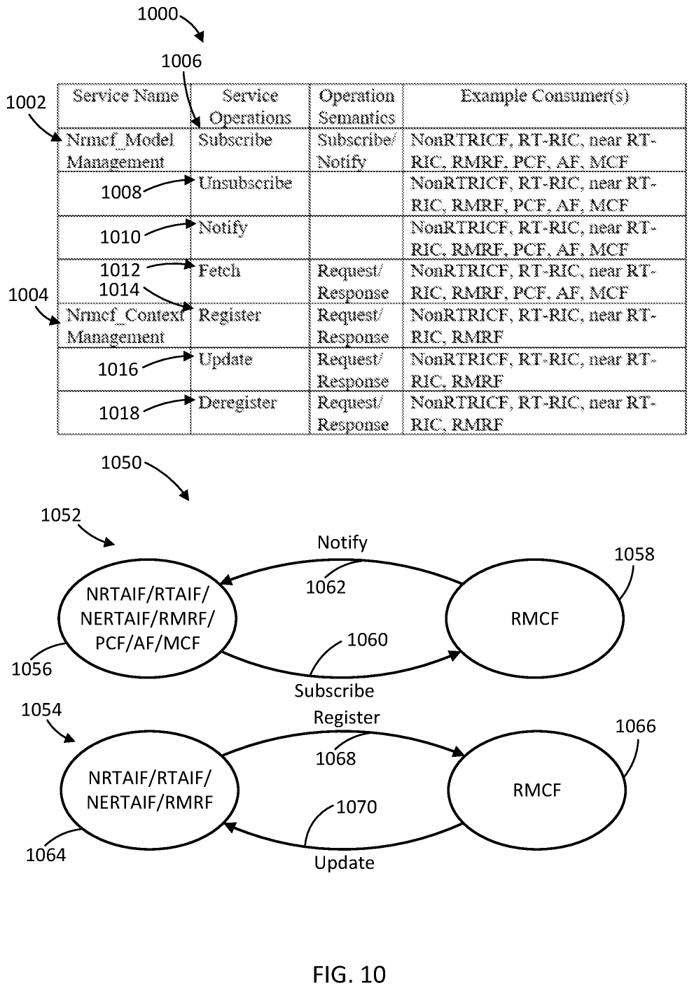

FIG. 10 illustrates an example of services of an RMCF in accordance with some embodiments. In particular, FIG. 10 illustrates a table 1000 that shows services and service operations that may be performed with an RMCF. Further, FIG. 10 illustrates signaling diagrams 1050 that illustrates signals that may be exchanged with an RMCF. The services and signaling illustrated by FIG. 10 may be performed by an RMCF (such as the RMCF 418 (FIG. 4) and/or the RMCF 518 (FIG. 5)) and/or a CMCF (such as the CMCF 612 (FIG. 6)). For brevity, the services and signaling are described as being performed by an RMCF, although it should be understood that the services and/or signaling may be performed by a CMCF in other embodiments.

As can be seen from the table 1000, the RMCF may provide two services, a service named Nrmcf_ModelManagement 1002 and a service named Nrmcf_ContextManagement 1004. The Nrmcf_ModelManagement 1002 service and/or the Nrmcf_ContextManagement 1004 service provided by the RMCF may include managing and/or sharing AI/ML models received from different RANs and/or CN NFs. Each of the services may provide different service operations.

The RMCF may perform a subscribe operation 1006. The subscribe operation 1006 may include a consumer subscribing to one or more AI/ML models via the RMCF. The subscribe operation 1006 may utilize subscribe and notify signaling to perform the operation. The RMCF may perform the subscribe operation 1006 with a consumer, such as an NonRTRICF, an RT-RIC, a near RT-RIC, an RMRF, a PCF, an AF, and/or an MCF. The subscribe operation 1006 may be performed as part of the Nrmcf_ModelManagement 1002 service.

The RMCF may further perform an unsubscribe operation 1008. The unsubscribe operation 1008 may include a consumer requesting termination of a subscription to one or more AI/ML models. The RMCF may perform the unsubscribe operation 1008 with a consumer, such as an NonRTRICF, an RT-RIC, a near RT-RIC, an RMRF, a PCF, an AF, and/or an MCF. The unsubscribe operation 1008 may be performed as part of the Nrmcf_ModelManagement 1002 service.

The RMCF may further perform a notify operation 1010. The notify operation 1010 may include the RMCF sending notification to endpoints corresponding to a subscription. The RMCF may process and format the AI/ML models for the consumer and/or the endpoints. The RMCF may perform the notify operation 1010 with a consumer, such as an NonRTRICF, an RT-RIC, a near RT-RIC, an RMRF, a PCF, an AF, and/or an MCF. The notify operation 1010 may be performed as part of the Nrmcf_ModelManagement 1002 service.

The RMCF may further perform a fetch operation 1012. The fetch operation 1012 may include one or more AI/ML models being fetched from the RMCF. The fetch operation 1012 may utilize request and response signaling to perform the operation. The RMCF may perform the fetch operation 1012 with a consumer, such as an NonRTRICF, an RT-RIC, a near RT-RIC, an RMRF, a PCF, an AF, and/or an MCF. The fetch operation 1012 may be performed as part of the Nrmcf_ModelManagement 1002 service.

The RMCF may further perform a register operation 1014. The register operation 1014 may include a consumer requesting registration with the RMCF and the RMCF registering the consumer. The register operation 1014 may utilize request and response signaling to perform the operation. The RMCF may perform the register operation 1014 with a consumer, such as an NonRTRICF, an RT-RIC, a near RT-RIC, and/or an RMRF. The register operation 1014 may be performed as part of the Nrmcf_ContextManagement 1004 service.

The RMCF may further perform an update operation 1016. The update operation 1016 may include a consumer requesting update of registration data with the RMCF and the RMCF updating the registration data. The update operation 1016 may utilize request and response signaling to perform the operation. The RMCF may perform the update operation 1016 with a consumer, such as an NonRTRICF, an RT-RIC, a near RT-RIC, and/or an RMRF. The update operation 1016 may be performed as part of Nrmcf_ContextManagement 1004 service.

The RMCF may further perform a deregister operation 1018. The deregister operation 1018 may include a consumer requesting deregistration with the RMCF and the RMCF deregistering the consumer. The deregister operation 1018 may utilize request and response signaling to perform the operation. The RMCF may perform the deregister operation 1018 with a consumer, such as an NonRTRICF, an RT-RIC, a near RT-RIC, and/or an RMRF. The deregister operation 1018 may be performed as part of Nrmcf_ContextManagement 1004 service.

The signaling diagrams 1050 illustrate example signaling of the notify and subscribe signaling, and the register and update signaling of the service operations. In particular, the signaling diagrams 1050 include a first diagram 1052 that illustrates example notify and subscribe signaling. The signals illustrated in the notify and subscribe signaling of the first diagram 1052 may be implemented for the service operations indicated as utilizing subscribe and notify signaling described above. The signaling diagrams 1050 further include a second diagram 1054 that illustrates example register and update signaling. The signals illustrated in the register and update signaling of the second diagram 1054 may be implemented for the service operations indicated as utilizing request and response signaling described above.

The first diagram 1052 illustrates example notify and subscribe signaling between a consumer 1056 and an RMCF 1058. The consumer 1056 may comprise an NRTAIF, an RTAIF, an NERTAIF, an RMRF, a PCF, an AF, and/or an MCF. The consumer 1056 may depend on the service operation being performed, as described above in accordance with the service operations.

The consumer 1056 may transmit a subscribe message 1060. The subscribe message 1060 may indicate one or more AI/ML models from the RMCF to which the consumer 1056 is requesting to subscribe. For example, the subscribe message 1060 may indicate one or more AI/ML models to which the consumer 1056 would like to subscribe. The consumer 1056 may transmit the subscribe message 1060 to the RMCF 1058.

The RMCF 1058 may receive the subscribe message 1060 from the consumer 1056. The RMCF 1058 may perform the service operation as indicated by the subscribe message 1060. The RMCF 1058 may transmit a notify message 1062 to the consumer 1056. In the instance where the RMCF 1058 performs the service operation, the notify message 1062 may indicate that the service operation has been performed. In the instance where the RMCF 1058 is unable to perform the service operation indicated by the subscribe message 1060, the RMCF 1058 may not perform the service operation and the notify message 1062 may indicate that the RMCF 1058 has not performed the service operation.

The second diagram 1054 illustrates example register and update signaling between a consumer 1064 and an RMCF 1066. The register and update signaling may be a form of request and response signaling, and may be utilized by the service operations that implement request and response signaling described above. The consumer 1064 may comprise an NRTAIF, an RTAIF, an NERTAIF, and/or an RMRF. The consumer 1064 may depend on the service operation being performed, as described above in accordance with the service operations.

The consumer 1064 may transmit a register message 1068. The register message 1068 may indicate a service operation to be performed and data related to the service operation. For example, the register message 1068 may indicate that the consumer 1064 is to be registered with the RMCF 1066 and/or data for registering the consumer 1064 with the RMCF 1066. The consumer 1064 may transmit the register message 1068 to the RMCF 1066.

The RMCF 1066 may receive the register message 1068 from the consumer 1064. The RMCF 1066 may perform the service operation as indicated by the register message 1068. The RMCF 1066 may transmit an update message 1070 to the consumer 1064. In the instance where the RMCF 1066 performs the service operation, the update message 1070 may indicate that the service operation has been performed. In the instance where the RMCF 1066 is unable to perform the service operation indicated by the register message 1068, the RMCF 1066 may not perform the service operation and the update message 1070 may indicate that the RMCF 1066 has not performed the service operation.

In other instances, the RMCF 1066 may transmit the update message 1070. The update message 1070 may indicate an update to be made to the consumer 1064. For example, the update message 1070 may indicate that a configuration of the consumer 1064 is to be updated. The RMCF 1066 may transmit the update message 1070 to the consumer 1064.

The consumer 1064 may receive the update message 1070 from the RMCF 1066. The consumer 1064 may perform the service operation indicated by the update message 1070. The consumer 1064 may transmit the register message 1068 to the RMCF 1066. In the instance where the consumer 1064 performs the service operation, the register message 1068 may indicate that the service operation has been performed. In the instance where the consumer 1064 is unable to perform the service operation indicated by the update message 1070, the consumer 1064 may not perform the service operation and the register message 1068 may indicate that the consumer 1064 has not performed the service operation.

While the table 1000 indicates a particular service name and service operations, it should be understood that the service name and/or the service operations may be labeled differently in other instances. Further, while the signaling diagrams 1050 illustrate certain signals to support the services, it should be understood that other signals may be transmitted between the subscriber and the RMCF to support the service operations in other embodiments.

The MRF service may be used to store AI/ML model in the MRF, retrieve AI/ML model from an MRF, or delete AI/ML model from an MRF. The consumer can be MCF, or another MRF, RMCF, ADRF or NRTAIF, RTAIF, NERTAIF. MRF can request to store/retrieve model from RMRF via MCF/RMCF. RAN AI function (e.g., NRTAIF, RTAIF, NERTAIF) can retrieve model from MRF. Each stored model has a unified model ID which can be found in MCF.

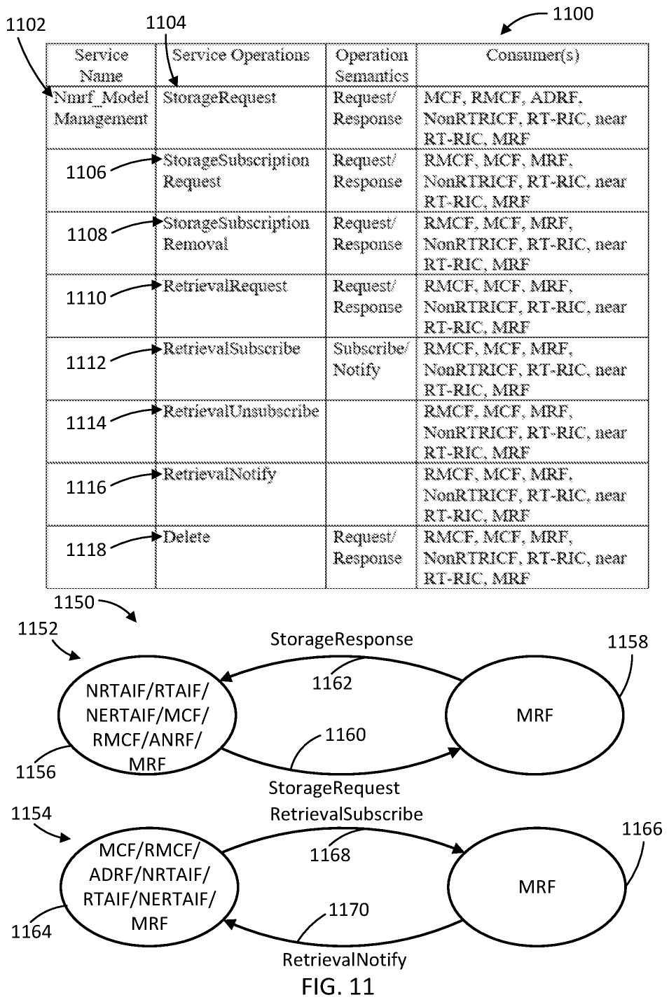

FIG. 11 illustrates an example of services of an MRF in accordance with some embodiments. In particular, FIG. 11 illustrates a table 1100 that shows services and service operations that may be performed with an MRF. Further, FIG. 11 illustrates signaling diagrams 1150 that illustrate signals that may be exchanged with an MRF. The services and signaling illustrated by FIG. 11 may be performed by an MRF (such as the MRF 426 (FIG. 4) and/or the MRF 548 (FIG. 5)) and/or a CMRF (such as the CMRF 610 (FIG. 6)). For brevity, the services and signaling are described as being performed by an MRF, although it should be understood that the services and/or signaling may be performed by a CMRF in other embodiments.

As can be seen from the table 1100, the MRF may provide a service named Nmrf_ModelManagement 1102. The Nmrf_ModelManagement 1102 service provided by the MRF may include storing and/or retrieving models.

The MRF may provide one or more service operations related to storage of models. For example, the MRF may perform a storage/request (StorageRequest) operation 1104. The StorageRequest operation 1104 may include a consumer requesting the MRF to store one or more models and the MRF storing the models. The StorageRequest operation 1104 may utilize request and response signaling to perform the operation. The MRF may perform the StorageRequest operation 1104 with a consumer, such as an MCF, an RMCF, an ADRF, a NonRTRICF, an RT-RIC, a near RT-RIC, and/or another MRF.

The MRF may further perform a storage/subscription/request (StorageSubscriptionRequest) operation 1106. The StorageSubscriptionRequest operation 1106 may include a consumer requesting that the MRF initiate a subscription for models to receive and store the models. The StorageSubscriptionRequest operation 1106 may utilize request and response signaling to perform the operation. The MRF may perform the StorageSubscriptionRequest operation 1106 with a consumer, such as an MCF, an RMCF, an ADRF, a NonRTRICF, an RT-RIC, a near RT-RIC, and/or another MRF.

The MRF may further perform a storage/subscription/removal (StorageSubscriptionRemoval) operation 1108. The StorageSubscriptionRemoval operation 1108 may include a consumer requesting that the MRF terminate a subscription for models that the MRF has been receiving and storing. The StorageSubscriptionRemoval operation 1108 may utilize request and response signaling to perform the operation. The MRF may perform the StorageSubscriptionRemoval operation 1108 with a consumer, such as an MCF, an RMCF, an ADRF, a NonRTRICF, an RT-RIC, a near RT-RIC, and/or another MRF.

The MRF may further perform a retrieval/request (RetrievalRequest) operation 1110. The RetrievalRequest operation 1110 may include a consumer requesting the MRF to retrieve models and the MRF providing the models to the consumer. The RetrievalRequest operation 1110 may utilize request and response signaling to perform the operation. The MRF may perform the RetrievalRequest operation 1110 with a consumer, such as an MCF, an RMCF, an ADRF, a NonRTRICF, an RT-RIC, a near RT-RIC, and/or another MRF.

The MRF may further perform a retrieval/subscribe (RetrievalSubscribe) operation 1112. The RetrievalSubscribe operation 1112 may include a consumer requesting stored models from the MRF, and future notifications containing corresponding models received by the MRF. The MRF may provide the models and the future notifications to the consumer. The RetrievalSubscribe operation 1112 may utilize subscribe and notify signaling to perform the operation. The MRF may perform the RetrievalSubscribe operation 1112 with a consumer, such as an MCF, an RMCF, an ADRF, a NonRTRICF, an RT-RIC, a near RT-RIC, and/or another MRF.

The MRF may further perform a retrieval/unsubscribe (RetrievalUnsubscribe) operation 1114. The RetrievalUnsubscribe operation 1114 may include a consumer requesting that the MRF terminate a subscription of the MRF sending models to the consumer. The MRF may perform the RetrievalUnsubscribe operation 1114 with a consumer, such as an MCF, an RMCF, an ADRF, a NonRTRICF, an RT-RIC, a near RT-RIC, and/or another MRF.

The MRF may further perform a retrieval/notify (RetrievalNotify) operation 1116. The RetrievalNotify operation 1116 may include the MRF providing models to the consumer, and/or providing instructions to the consumer to fetch the models from the MRF. The MRF may perform the RetrievalNotify operation 1116 with a consumer, such as an MCF, an RMCF, an ADRF, a NonRTRICF, an RT-RIC, a near RT-RIC, and/or another MRF.

The MRF may further perform a delete operation 1118. The delete operation 1118 may include the MRF deleting one or more models stored by the MRF. A consumer may request that the deletion of the models. The delete operation 1118 may utilize request and response signaling to perform the operation. The MRF may perform the delete operation 1118 with a consumer, such as an MCF, an RMCF, an ADRF, a NonRTRICF, an RT-RIC, a near RT-RIC, and/or another MRF.

The signaling diagrams 1150 illustrate example signaling of the request and response signaling, and the subscribe and notify signaling of the service operations. In particular, the signaling diagrams 1150 include a first diagram 1152 that illustrates example request and response signaling. The signals illustrated in the request and response signaling of the first diagram 1152 may be implemented for the service operations indicated as utilizing request and response signaling described above. The signaling diagrams 1150 further include a second diagram 1154 that illustrates example subscribe and notify signaling. The signals illustrated in the subscribe and notify signaling of the second diagram 1154 may be implemented for the service operations indicated as utilizing subscribe and notify signaling described above.

The first diagram 1152 illustrates example request and response signaling between a consumer 1156 and an MRF 1158. The consumer 1156 may comprise an NRTAIF, an RTAIF, an NERTAIF, an MCF, an RMCF, an automatic neighbor relation function (ANRF), and/or another MRF. The consumer 1156 may depend on the service operation being performed, as described above in accordance with the service operations.

The consumer 1156 may transmit a storage/request (StorageRequest) message 1160. The StorageRequest message 1160 may indicate a service operation to be performed and data related to the service operation. For example, the StorageRequest message 1160 may indicate one or more models to be stored, and/or one or more models to be retrieved. The consumer 1156 may transmit the StorageRequest message 1160 to the MRF 1158.

The MRF 1158 may receive the StorageRequest message 1160 from the consumer 1156. The MRF 1158 may perform the service operation as indicated by the StorageRequest message 1160. The MRF 1158 may transmit a storage/response (StorageResponse) message 1162 to the consumer 1156. In the instance where the MRF 1158 performs the service operation, the StorageResponse message 1162 may indicate that the service operation has been performed. In the instance where the MRF 1158 is unable to perform the service operation indicated by the StorageRequest message 1160, the MRF 1158 may not perform the service operation and the StorageResponse message 1162 may indicate that the MRF 1158 has not performed the service operation.

The second diagram 1154 illustrates example subscribe and notify signaling between a consumer 1164 and an MRF 1166. The consumer 1164 may comprise an MCF, an RMCF, an ADRF, an NRTAIF, an RTAIF, an NERTAIF, and/or an MRF. The consumer 1164 may depend on the service operation being performed, as described above in accordance with the service operations.

The consumer 1164 may transmit a retrieval/subscribe (RetrievalSubscribe) message 1168. The RetrievalSubscribe message 1168 may indicate a service operation to be performed and data related to the service operation. For example, the RetrievalSubscribe message 1168 may indicate models to be retrieved and/or for which notifications are to be provided. The consumer 1164 may transmit the RetrievalSubscribe message 1168 to the MRF 1166.

The MRF 1166 may receive the RetrievalSubscribe message 1168 from the consumer 1164. The MRF 1166 may perform the service operation as indicated by the RetrievalSubscribe message 1168. The MRF 1166 may transmit a retrieval/notify (RetrievalNotify) message 1170 to the consumer 1164. In the instance where the MRF 1166 performs the service operation, the RetrievalNotify message 1170 may indicate that the service operation has been performed. In the instance where the MRF 1166 is unable to perform the service operation indicated by the RetrievalSubscribe message 1168, the MRF 1166 may not perform the service operation and the RetrievalNotify message 1170 may indicate that the MRF 1166 has not performed the service operation.

While the table 1100 indicates a particular service name and service operations, it should be understood that the service name and/or the service operations may be labeled differently in other instances. Further, while the signaling diagrams 1150 illustrate certain signals to support the services, it should be understood that other signals may be transmitted between the subscriber and the MRF to support the service operations in other embodiments.

The MCF service can coordinate with other NFs to manage or coordinate the AI/ML model in the MRF. For model management service, the consumer can be NRTAIF, RTAIF, NERTAIF, RDRF, PCF, AF, MRF. For context management service, the consumer can be NRTAIF, RTAIF, NERTAIF, MRF. Different from data management (e.g., retrieve model), the context management is for other NFs to identify the data or analytics in MCF (e.g., retrieve model ID). All model IDs are stored and managed in MCF. UE first finds RDCF via NRF, and then checks suitable dataset ID via RDCF.

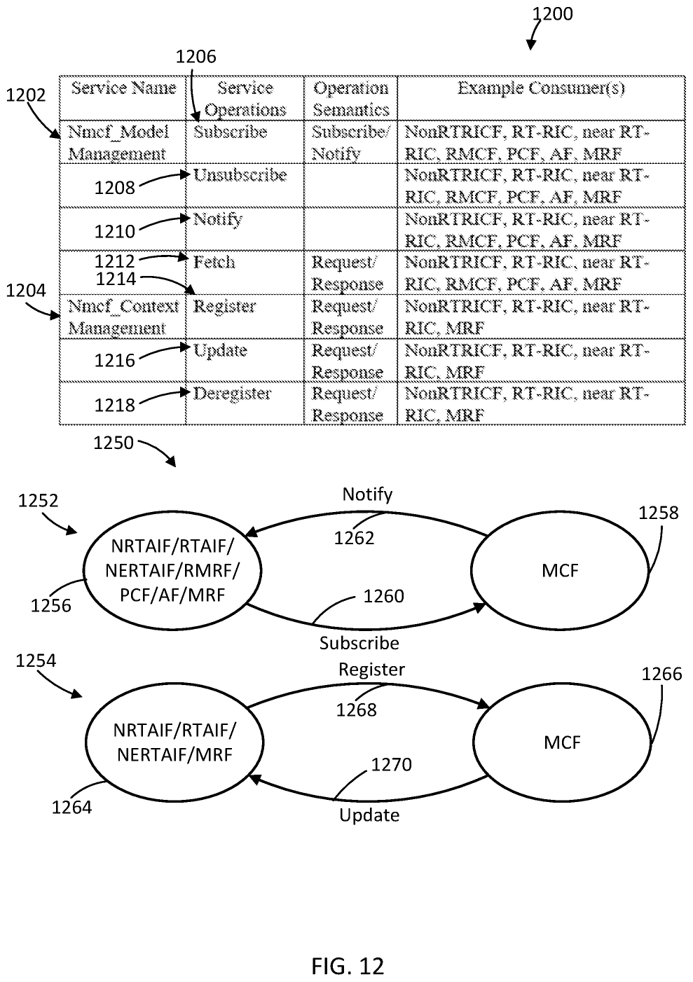

FIG. 12 illustrates an example of services of an MCF in accordance with some embodiments. In particular, FIG. 12 illustrates a table 1200 that shows services and service operations that may be performed with an MCF. Further, FIG. 12 illustrates signaling diagrams 1250 that illustrates signals that may be exchanged with an RDCF. The services and signaling illustrated by FIG. 12 may be performed by an MCF (such as the MCF 428 (FIG. 4) and/or the MCF 550 (FIG. 5)) and/or a CMCF (such as the CMCF 612 (FIG. 6)). For brevity, the services and signaling are described as being performed by an RMCF, although it should be understood that the services and/or signaling may be performed by a CMCF in other embodiments.

As can be seen from the table 1200, the MCF may provide two services, a service named Nmcf_ModelManagement 1202 and a service named Nmcf_ContextManagement 1204. The Nmcf_ModelManagement 1202 service and/or the Nmcf_ContextManagement 1204 service provided by the MCF may include managing and/or sharing models. Each of the services may provide different service operations.

The MCF may perform a subscribe operation 1206. The subscribe operation 1206 may include a consumer subscribing to one or more models via the MCF. The subscribe operation 1206 may utilize subscribe and notify signaling to perform the operation. The MCF may perform the subscribe operation 1206 with a consumer, such as an NonRTRICF, an RT-RIC, a near RT-RIC, an RMCF, a PCF, an AF, and/or an MRF. The subscribe operation 1206 may be performed as part of the Nmcf_ModelManagement 1202 service.

The MCF may further perform an unsubscribe operation 1208. The unsubscribe operation 1208 may include a consumer requesting termination of a subscription to one or more models. The MCF may perform the unsubscribe operation 1208 with a consumer, such as an NonRTRICF, an RT-RIC, a near RT-RIC, an RMCF, a PCF, an AF, and/or an MRF. The unsubscribe operation 1208 may be performed as part of the Nmcf_ModelManagement 1202 service.

The MCF may further perform a notify operation 1210. The notify operation 1210 may include the MCF sending notification to endpoints corresponding to a subscription. The MCF may process and format the models for the consumer and/or the endpoints. The MCF may perform the notify operation 1210 with a consumer, such as an NonRTRICF, an RT-RIC, a near RT-RIC, an RMCF, a PCF, an AF, and/or an MRF. The notify operation 1210 may be performed as part of the Nmcf_ModelManagement 1202 service.

The MCF may further perform a fetch operation 1212. The fetch operation 1212 may include one or more models being fetched from the MCF. The fetch operation 1212 may utilize request and response signaling to perform the operation. The RMCF may perform the fetch operation 1212 with a consumer, such as an NonRTRICF, an RT-RIC, a near RT-RIC, an RMCF, a PCF, an AF, and/or an MRF. The fetch operation 1212 may be performed as part of the Nmcf_ModelManagement 1202 service.

The MCF may further perform a register operation 1214. The register operation 1214 may include a consumer requesting registration with the MCF and the MCF registering the consumer. The register operation 1214 may utilize request and response signaling to perform the operation. The MCF may perform the register operation 1214 with a consumer, such as an NonRTRICF, an RT-RIC, a near RT-RIC, and/or an MRF. The register operation 1214 may be performed as part of the Nmcf_ContextManagement 1204 service.

The MCF may further perform an update operation 1216. The update operation 1216 may include a consumer requesting update of registration data with the MCF and the MCF updating the registration data. The update operation 1216 may utilize request and response signaling to perform the operation. The MCF may perform the update operation 1216 with a consumer, such as an NonRTRICF, an RT-RIC, a near RT-RIC, and/or an MRF. The update operation 1216 may be performed as part of Nmcf_ContextManagement 1204 service.

The MCF may further perform a deregister operation 1218. The deregister operation 1218 may include a consumer requesting deregistration with the MCF and the MCF deregistering the consumer. The deregister operation 1218 may utilize request and response signaling to perform the operation. The MCF may perform the deregister operation 1218 with a consumer, such as an NonRTRICF, an RT-RIC, a near RT-RIC, and/or an MRF. The deregister operation 1218 may be performed as part of Nmcf_ContextManagement 1204 service.

The signaling diagrams 1250 illustrate example signaling of the notify and subscribe signaling, and the register and update signaling of the service operations. In particular, the signaling diagrams 1250 include a first diagram 1252 that illustrates example notify and subscribe signaling. The signals illustrated in the notify and subscribe signaling of the first diagram 1252 may be implemented for the service operations indicated as utilizing subscribe and notify signaling described above. The signaling diagrams 1250 further include a second diagram 1254 that illustrates example register and update signaling. The signals illustrated in the register and update signaling of the second diagram 1254 may be implemented for the service operations indicated as utilizing request and response signaling described above.

The first diagram 1252 illustrates example notify and subscribe signaling between a consumer 1256 and an MCF 1258. The consumer 1256 may comprise an NRTAIF, an RTAIF, an NERTAIF, an RMRF, a PCF, an AF, and/or an MRF. The consumer 1256 may depend on the service operation being performed, as described above in accordance with the service operations.

The consumer 1256 may transmit a subscribe message 1260. The subscribe message 1260 may indicate one or more models from the MCF to which the consumer 1256 is requesting to subscribe. For example, the subscribe message 1260 may indicate one or more models to which the consumer 1256 would like to subscribe. The consumer 1256 may transmit the subscribe message 1260 to the MCF 1258.

The MCF 1258 may receive the subscribe message 1260 from the consumer 1256. The MCF 1258 may perform the service operation as indicated by the subscribe message 1260. The MCF 1258 may transmit a notify message 1262 to the consumer 1256. In the instance where the MCF 1258 performs the service operation, the notify message 1262 may indicate that the service operation has been performed. In the instance where the MCF 1258 is unable to perform the service operation indicated by the subscribe message 1260, the MCF 1258 may not perform the service operation and the notify message 1262 may indicate that the MCF 1258 has not performed the service operation.

The second diagram 1254 illustrates example register and update signaling between a consumer 1264 and an MCF 1266. The register and update signaling may be a form of request and response signaling, and may be utilized by the service operations that implement request and response signaling described above. The consumer 1264 may comprise an NRTAIF, an RTAIF, an NERTAIF, and/or an MRF. The consumer 1264 may depend on the service operation being performed, as described above in accordance with the service operations.

The consumer 1264 may transmit a register message 1268. The register message 1268 may indicate a service operation to be performed and data related to the service operation. For example, the register message 1268 may indicate that the consumer 1264 is to be registered with the MCF 1266 and/or data for registering the consumer 1264 with the MCF 1266. The consumer 1264 may transmit the register message 1268 to the MCF 1266.

The MCF 1266 may receive the register message 1268 from the consumer 1264. The MCF 1266 may perform the service operation as indicated by the register message 1268. The MCF 1266 may transmit an update message 1270 to the consumer 1264. In the instance where the MCF 1266 performs the service operation, the update message 1270 may indicate that the service operation has been performed. In the instance where the MCF 1266 is unable to perform the service operation indicated by the register message 1268, the MCF 1266 may not perform the service operation and the update message 1270 may indicate that the MCF 1266 has not performed the service operation.

In other instances, the MCF 1266 may transmit the update message 1270. The update message 1270 may indicate an update to be made to the consumer 1264. For example, the update message 1270 may indicate that a configuration of the consumer 1264 is to be updated. The MCF 1266 may transmit the update message 1270 to the consumer 1264.

The consumer 1264 may receive the update message 1270 from the MCF 1266. The consumer 1264 may perform the service operation indicated by the update message 1270. The consumer 1264 may transmit the register message 1268 to the MCF 1266. In the instance where the consumer 1264 performs the service operation, the register message 1268 may indicate that the service operation has been performed. In the instance where the consumer 1264 is unable to perform the service operation indicated by the update message 1270, the consumer 1264 may not perform the service operation and the register message 1268 may indicate that the consumer 1264 has not performed the service operation.

While the table 1200 indicates a particular service name and service operations, it should be understood that the service name and/or the service operations may be labeled differently in other instances. Further, while the signaling diagrams 1250 illustrate certain signals to support the services, it should be understood that other signals may be transmitted between the subscriber and the MCF to support the service operations in other embodiments.

A control plane approach and user plane approach to achieve aligned AI/ML function between Network and UE may be implemented. Aligned AI/ML function means unified AI/ML model is used across different Network and UE vendor for AI/ML. For example, an aligned AI/ML function may be implemented. The aligned AI/ML function may allow a unified AI/ML model to be utilized by different network vendors and/or different UE vendors.

A control plane approach means that the network stores and manages all AI/ML models. UE needs to use RRC signaling to request suitable AI/ML model based on use case. It can achieve good multi-vendor inter-operation. For example, in a control plane approach, a network may store and manage one or more AI/ML models. UEs may transmit requests via RRC signaling to the network for AI/ML models stored by the network. The AI/ML model requested by a UE may be based on a use case of the UE. The network may provide the AI/ML model requested by the UE to the UE.

A user plane approach may include an implementation based AI/ML approach. For example, UE vendor and Network vendor may use different AI/ML models, which is hard for multi-vendor interoperation. The user plane approach may be transparent to third generation partnership project (3GPP) specification. For example, different UEs and/or different networks may utilize different AI/ML models. The different UEs and/or different networks implementing different AI/ML models may present a challenge with supporting the different AI/ML models that are implemented by the different UEs and/or different networks.

This disclosure focuses on control plane approaches. For example, this disclosure focuses at least in part on a control plane approach.

New RRC messages are introduced between UE and centralized unit (CU) to request suitable AI/ML model from NW. For example, a UE (such as the UE 546 (FIG. 5) and/or the UE 642 (FIG. 6)) may utilize RRC messages to request an AI/ML model from a network. The UE may transmit the RRC messages to a CU-CP (such as the 6G CU-CP element 422 (FIG. 4), the 6G CU-CP element 522 (FIG. 5), and/or the 6G CU-CP element 618 (FIG. 6)) of the network. The network may utilize RRC messages to provide the AI/ML model to the UE.

Approaches described herein may implement a model request/response message that can request suitable AI/ML model from NW. The model request/response message may be an RRC message. The model request/response message may receive input of scenario, channel, traffic, and/or mobility status. For example, model request and model response RRC messages may be utilized for requesting an AI/ML model from the NW. The model request and response procedure (including the model request and model response RRC messages) may have inputs of scenario, channel, traffic, and/or mobility status. Scenario can be “CSI compression” or “mobility” as example. Traffic can be traffic type (e.g., extended reality (XR), ultra-high reliability and low latency (URLLC)) and traffic loading. Mobility status can be mobility speed and/or mobility trajectory. The model request/response message may output Model ID, model structure, and/or model parameters. For example, the model request and response procedure may have outputs of model ID, model structure, and/or model parameters. Model ID is generated by RMRF and/or MRF, and it is unique across UE vendors and NW vendors. For example, model IDs corresponding to AI/ML models may be generated by an RMRF and/or an MRF. The model IDs generated for each of the AI/ML models may be unique.

Approaches described herein may implement a model update/response message that can update AI/ML model from NW. The model update/response message may be an RRC message. The model update/response message may receive input of Model ID and/or trained model parameters. For example, model update and model response RRC messages may be utilized with updating an AI/ML model from the NW. The update of the AI/ML model may be an update of an AI/ML model being utilized by a UE. The model update and response procedure (including the model update and model response RRC messages) may have inputs of model ID and/or trained model parameters. The model structure is not needed because Model ID is unique to identify correct Model. Trained parameter is optional for UE trained parameters based on its local dataset. For example, the trained model parameters may be optional as an input of the model update and response procedure based on a local dataset of a UE and/or AI/ML model. The model update/response message may output Model ID and/or updated model parameters. For example, the model update and response procedure may have outputs of model ID and/or updated model parameters. Model ID may be different from the one of input, which means NW wants UE to switch to another model. For example, the model ID output by the model update and response procedure may be different than the model ID used as an input to the model update and response procedure. The model ID being different may indicated that the NW is requesting the UE to switch to another AI/ML model. Update parameters can be updated parameters based on core network further fusion.

An example of AI-based CSI compression may be described as follows.

After UE sends model request message to 6G RAN, 6G RAN forwards the message to RTAIF because CSI compression requires real time inference. For example, a UE may transmit a model request message to a RAN (such as the RAN 402 (FIG. 4), the RAN 502 (FIG. 5), and/or the combined RAN/CN 602 (FIG. 6)). The model request message may be a RRC message. The model request message may request that the RAN provide an AI/ML model to the UE. The RAN may forward the model request message to an RTAIF (such as the RTAIF 540 (FIG. 5), and/or the RTAIF 636 (FIG. 6)).

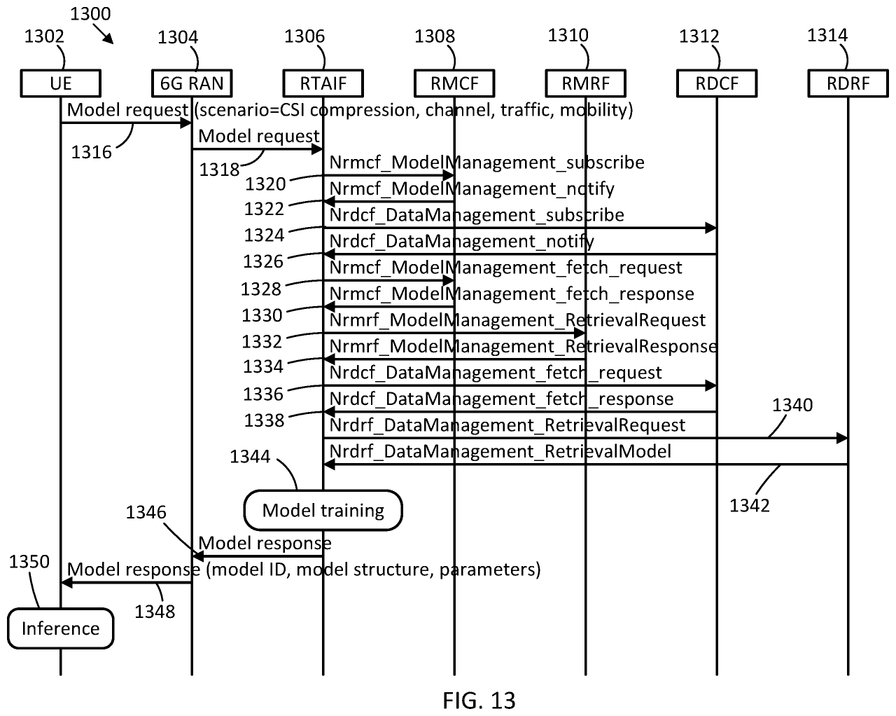

In this example, scenario=CSI compression, which requires RT-RIC handling. In particular, the scenario of the RAN receiving the model request message and forwarding the model request message to the RTAIF may be a CSI compression scenario. FIG. 13 illustrates signaling for an example scenario of CSI compression.

Based on channel, traffic and mobility status provided by the UE, RTAIF identifies the model ID of the most suitable model from RMCF, and then retrieves such model structure and parameters from RMRF based on the model ID. For example, the RTAIF may query the RMCF for information about models stored by the RMRF. The RTAIF may determine the model stored by the RMRF that is most suitable for the UE based on the channel, traffic, and/or mobility status indicated by the UE, the most suitable model being determined from the models stored by the RMRF. The RTAIF may further identify a model ID corresponding to the most suitable model from the RMCF. The RTAIF may retrieve the model structure and parameters for the most suitable model from the RMRF using the model ID.

Based on the scenario (e.g., CSI compression), RTAIF identifies the dataset ID of the most suitable dataset from RDCF, and then retrieves such dataset from RDRF based on the dataset ID. For example, the RTAIF may query the RDCF for information about datasets stored by the RDRF. The RTAIF may determine the dataset stored by the RDRF that is most suitable for the UE based on the scenario, the most suitable dataset being determined from the datasets stored by the RDRF. The RTAIF may further identify a dataset ID corresponding to the most suitable dataset from the RDCF. The RTAIF may retrieve the dataset from the RDRF using the dataset ID. As CSI compression has no coupling with other gNB, RTAIF doesn't need to retrieve more data from core network.

RTAIF may perform offline training based on retrieved model and dataset. For example, the RTAIF may perform training with the model retrieved from the RMRF and the dataset retrieved from the RDRF. The RTAIF may perform the training offline. RTAIF sends model ID, model structure and trained parameters to UE via model response message. For example, the RTAIF may provide the model ID retrieved from the RMCF, the model structure retrieved from the RMRF, and/or the trained parameters resulting from the offline training by the RTAIF to the UE via a model response message. The UE performs inference based on received model and local channel observation. It can also be gNB to perform inference and send inference results to the UE.

FIG. 13 illustrates an example of AI based CSI compression signaling in accordance with some embodiments. In particular, FIG. 13 illustrates a signaling chart 1300 that illustrates messages that may be exchanged between a UE and a network for providing an AI/ML model to the UE in accordance with some embodiments. The signals, or some portion thereof, illustrated in the signaling chart 1300 may comprise RRC signals in some embodiments.

The signaling chart 1300 may include a UE 1302. The UE 1302 may include one or more of the features of the UE 546 (FIG. 5), the UE 642 (FIG. 6), and/or the UE 1800 (FIG. 18). The UE 1302 may be connected to a network via a base station (such as the base station 202 (FIG. 2), the base station 306 (FIG. 3), the 6G RU element 544 (FIG. 5), and/or the 6G RU element 640 (FIG. 6)).

The signaling chart 1300 may include a 6G RAN 1304. The 6G RAN 1304 may include one or more of the features of the RAN 402 (FIG. 4), the RAN 502 (FIG. 5), combined RAN/CN 602 (FIG. 6), and/or the gNB 1900 (FIG. 19).

The signaling chart 1300 may include an RTAIF 1306. The RTAIF 1306 may include one or more of the features of the RTAIF 540 (FIG. 5) and/or the RTAIF 636 (FIG. 6).

The signaling chart 1300 may include an RMCF 1308. The RMCF 1308 may include one or more of the features of the RMCF 418 (FIG. 4) and/or the RMCF 518 (FIG. 5). In other embodiments, the RMCF 1308 may comprise a CMCF, where the CMCF includes one or more of the features of the CMCF 612 (FIG. 6).

The signaling chart 1300 may include an RMRF 1310. The RMRF 1310 may include one or more of the features of the RMRF 412 (FIG. 4) and/or the RMRF 512 (FIG. 5). In other embodiments, the RMRF 1310 may comprise a CMRF, where the CMRF includes one or more of the features of the CMRF 610 (FIG. 6).

The signaling chart 1300 may include an RDCF 1312. The RDCF 1312 may include one or more of the features of the RDCF 414 (FIG. 4) and/or the RDCF 514 (FIG. 5). In other embodiments, the RDCF 1312 may comprise a CDCF, where the CDCF may include one or more of the features of the CDCF 614 (FIG. 6).

The signaling chart 1300 may include an RDRF 1314. The RDRF 1314 may include one or more of the features of the RDRF 408 (FIG. 4) and/or the RDRF 508 (FIG. 5). In other embodiments, the RDRF 1314 may comprise a CDRF, where the CDRF may include one or more of the features of the CDRF 616 (FIG. 6).

The UE 1302 may determine to request an AI/ML model. The UE 1302 may generate and transmit a model request message 1316 to the 6G RAN 1304. The model request message 1316 may be an RRC message. The model request message 1316 may indicate a scenario, a channel, traffic, and/or a mobility status related to the UE 1302. In this instance, the model request message 1316 may indicate that the scenario is CSI compression.

The 6G RAN 1304 may receive the model request message 1316 from the UE 1302. The 6G RAN 1304 may transmit a model request message 1318 to the RTAIF 1306. In some embodiments, the model request message 1318 may be the same as the model request message 1316, where the 6G RAN 1304 transmitting the model request message 1318 comprises forwarding the model request message 1316. In other embodiments, the 6G RAN 1304 may generate the model request message 1318 based on the model request message 1316. For example, the 6G RAN 1304 may generate the model request message 1318 as a copy of the model request message 1316 or may generate the model request message 1318 to include less or more parameters than the model request message 1316. In some of these embodiments, the model request message 1318 may include the channel, the traffic, and/or the mobility status related to the UE 1302.

The RTAIF 1306 may receive the model request message 1318 from the 6G RAN 1304. The RTAIF 1306 may determine the scenario, the channel, the traffic, and/or the mobility status related to the UE 1302 from the model request message 1318. The RTAIF 1306 may transmit a model management subscribe message 1320 to the RMCF 1308. The model management subscribe message 1320 may request the RMCF 1308 to subscribe the RTAIF 1306.

The RMCF 1308 may receive the model management subscribe message 1320 from the RTAIF 1306. The RMCF 1308 may determine that the RTAIF 1306 is to be subscribed to the RMCF 1308 based on the model management subscribe message 1320. The RMCF 1308 may subscribe the RTAIF 1306 based on the model management subscribe message 1320. The RMCF 1308 may provide notifications to the RTAIF 1306 based on the RTAIF 1306 being subscribed. The RMCF 1308 may transmit a model management notify message 1322 to the RTAIF 1306 to indicate that the RTAIF 1306 has been subscribed with the RMCF 1308. In instances where the RMCF 1308 is unable to subscribe the RTAIF 1306, the model management notify message 1322 may indicate that the RTAIF 1306 has not been subscribed with the RMCF 1308.

The RTAIF 1306 may receive the model management notify message 1322. The RTAIF 1306 may determine that it has been subscribed with the RMCF 1308 or has not been subscribed with the RMCF 1308 based on the model management notify message 1322. The RTAIF 1306 may transmit a data management subscribe message 1324 to the RDCF 1312. The data management subscribe message 1324 may request the RDCF 1312 to subscribe the RTAIF 1306.

The RDCF 1312 may receive the data management subscribe message 1324 from the RTAIF 1306. The RDCF 1312 may determine that the RTAIF 1306 is to be subscribed to the RDCF 1312 based on the data management subscribe message 1324. The RDCF 1312 may subscribe the RTAIF 1306 based on the data management subscribe message 1324. The RDCF 1312 may provide notifications to the RTAIF 1306 based on the RTAIF 1306 being subscribed. The RTAIF 1306 may transmit a data management notify message 1326 to the RTAIF 1306 to indicate that the RTAIF 1306 has been subscribed with the RDCF 1312. In instances where the RDCF 1312 is unable to subscribe the RTAIF 1306, the data management notify message 1326 may indicate that the RTAIF 1306 has not been subscribed with the RDCF 1312.

The RTAIF 1306 may receive the data management notify message 1326. The RTAIF 1306 may determine that it has been subscribed with the RDCF 1312 or has not been subscribed with the RDCF 1312 based on the data management notify message 1326. The RTAIF 1306 may transmit a model management fetch request 1328 to the RMCF 1308. The model management fetch request 1328 may request information regarding AI/ML models stored by the RMRF 1310.

The RMCF 1308 may receive the model management fetch request 1328 from the RTAIF 1306. The RMCF 1308 may determine that the RTAIF 1306 is requesting information regarding AI/ML models stored by the RMRF 1310. The RMCF 1308 may determine information regarding the AI/ML models stored by the RMRF 1310. The information regarding the AI/ML models may include model IDs corresponding to each of the AI/ML models as well as other information related to the AI/ML models. The RMCF 1308 may generate a model management fetch response message 1330. The model management fetch response message 1330 may include the information regarding the AI/ML models stored by the RMRF 1310. The RMCF 1308 may transmit the model management fetch response message 1330 to the RTAIF 1306.

The RTAIF 1306 may receive the model management fetch response message 1330 from the RMCF 1308. The RTAIF 1306 may identify the information regarding the AI/ML models stored by the RMRF 1310 from the model management fetch response message 1330. The RTAIF 1306 may determine an AI/ML model that is most suitable for the UE 1302 based on the information regarding the AI/ML models, the channel indicated by the model request message 1318, the traffic indicated by the model request message 1318, and/or the mobility status indicated by the model request message 1318. The RTAIF 1306 may further determine a model ID corresponding to the AI/ML model that is most suitable for the UE 1302.

The RTAIF 1306 may generate a model management retrieval request message 1332. The model management retrieval request message 1332 may indicate the model ID corresponding to the AI/ML model that was determined to be most suitable for the UE 1302. The model management retrieval request message 1332 may further indicate that the RTAIF 1306 is requesting the AI/ML model corresponding to the model ID. The RTAIF 1306 may transmit the model management retrieval request message 1332 to the RMRF 1310.

The RMRF 1310 may receive the model management retrieval request message 1332 from the RTAIF 1306. The RMRF 1310 may identify the model ID and determine that the model management retrieval request message 1332 is requesting that the AI/ML model corresponding to the model ID be provided to the RTAIF 1306. The RMRF 1310 may generate a model management retrieval response message 1334. In the instance where the RMRF 1310 has the AI/ML model corresponding to the model ID stored and the RMRF 1310 can identify the AI/ML model based on the model ID, the model management retrieval response message 1334 may include the AI/ML model. In the instance where the RMRF 1310 is unable to provide the AI/ML model corresponding to the model ID, the model management retrieval response message 1334 may indicate that the RMRF 1310 is unable to provide the AI/ML model. The RMRF 1310 may transmit the model management retrieval response message 1334 to the RTAIF 1306.

The RTAIF 1306 may receive the model management retrieval response message 1334 from the RMRF 1310. The RTAIF 1306 may identify and store the AI/ML model included in the model management retrieval response message 1334.

The RTAIF 1306 may generate a data management fetch request message 1336. The data management fetch request message 1336 may request information regarding datasets stored by the RDRF 1314. The RTAIF 1306 may transmit the data management fetch request message 1336 to the RDCF 1312.

The RDCF 1312 may receive the data management fetch request message 1336 from the RTAIF 1306. The RDCF 1312 may determine that the RTAIF 1306 is requesting information regarding datasets stored by the RDRF 1314. The RDCF 1312 may determine information regarding the datasets stored by the RDRF 1314. The information regarding the datasets may include dataset IDs corresponding to each of the datasets as well as other information related to the datasets. The RDCF 1312 may generate a data management fetch response message 1338. The data management fetch response message 1338 may include the information regarding the datasets stored by the RDRF 1314. The RDCF 1312 may transmit the data management fetch response message 1338 to the RTAIF 1306.

The RTAIF 1306 may receive the data management fetch response message 1338 from the RDCF 1312. The RTAIF 1306 may identify the information regarding the datasets stored by the RDRF 1314 from the data management fetch response message 1338. The RTAIF 1306 may determine a dataset that is most suitable for the UE 1302 based on the information regarding the datasets and/or the scenario indicated by the UE 1302. The RTAIF 1306 may further determine a dataset ID corresponding to the dataset that is most suitable for the UE 1302.

The RTAIF 1306 may generate a data management retrieval request message 1340. The data management retrieval request message 1340 may indicate the dataset ID corresponding to the dataset that was determined to be most suitable for the UE 1302. The data management retrieval request message 1340 may further indicate that the RTAIF 1306 is requesting the dataset corresponding to the dataset ID. The RTAIF 1306 may transmit the data management retrieval request message 1340 to the RDRF 1314.

The RDRF 1314 may receive the data management retrieval request message 1340 from the RTAIF 1306. The RDRF 1314 may identify the dataset ID and determine that the data management retrieval request message 1340 is requesting the dataset corresponding to the dataset ID be provided to the RTAIF 1306. The RDRF 1314 may generate a data management retrieval model message 1342. In the instance where the RDRF 1314 has the dataset corresponding to the dataset ID stored and the RDRF 1314 can identify the dataset based on the dataset ID, the data management retrieval model message 1342 may include the dataset. In the instance where the RDRF 1314 is unable to provide the dataset corresponding to the dataset ID, the data management retrieval model message 1342 may indicate that the RDRF 1314 is unable to provide the dataset. The RDRF 1314 may transmit the data management retrieval model message 1342 to the RTAIF 1306.

The RTAIF 1306 may receive the data management retrieval model message 1342 from the RDRF 1314. The RTAIF 1306 may identify and store the dataset included in the data management retrieval model message 1342.

In 1344, the RTAIF 1306 may perform model training. In particular, the RTAIF 1306 may perform model training of the model received in the model management retrieval response message 1334 with the dataset received in the data management retrieval model message 1342. The RTAIF 1306 may perform the model training in an offline training approach. The model training may result in the model being trained for utilization by the UE 1302.

The RTAIF 1306 may generate a model response message 1346. The model response message 1346 may include the trained model produced in the model training of 1344. For example, the model response message 1346 may include a model ID corresponding to the trained model, a model structure corresponding to the trained model, and/or one or more parameters for the trained model. The RTAIF 1306 may transmit the model response message 1346 to the 6G RAN 1304.

The 6G RAN 1304 may receive the model response message 1346 from the RTAIF 1306. The 6G RAN 1304 may transmit a model response message 1348 to the UE 1302. In some embodiments, the model response message 1348 may be the same as the model response message 1346, where the 6G RAN 1304 transmitting the model response message 1348 comprises forwarding the model response message 1346. In other embodiments, the 6G RAN 1304 may generate the model response message 1348 based on the model response message 1346. For example, the 6G RAN 1304 may generate the model response message 1348 as a copy of the model response message 1346 or may generate the model response message 1348 to include less or more parameters than the model response message 1346.

In some embodiments, the 6G RAN 1304 may further perform an inference for the trained AL/ML model to be utilized by the UE 1302. In these embodiments, the 6G RAN 1304 may generate inference results based on the inference. Further, the model response message 1348 may include the inference results in these embodiments.

The UE 1302 may receive the model response message 1348 from the 6G RAN 1304. The UE 1302 may determine the trained AI/ML model to be utilized by the UE 1302 based on the model response message 1348. In some embodiments, the UE 1302 may perform an inference in 1350 for the trained AI/ML model based on the model response message 1348. In embodiments where the 6G RAN 1304 performed the inference, the UE 1302 may determine the inference results from the model response message 1348. The UE 1302 may implement trained AI/ML based on the inference and/or the received inference results.

While the signaling chart 1300 illustrates one embodiment, it should be understood that more or less messages may be included in other embodiments. Further, one or more of the messages may be transmitted in a different order in other embodiments.

An example of AI-based mobility may be described as follows.

After UE sends model request message to 6G RAN, 6G RAN forwards the message to NRTAIF because mobility doesn't require real time inference. For example, the UE may transmit a model request message to a RAN (such as the RAN 402 (FIG. 4), the RAN 502 (FIG. 5), and/or the combined RAN/CN 602 (FIG. 6)). The model request message may be a RRC message. The model request message may request that the RAN provide an AI/ML model to the UE. The RAN may forward the model request message to an NRTAIF (such as the NRTAIF 520 (FIG. 5) and/or the NRTAIF 604 (FIG. 6)).

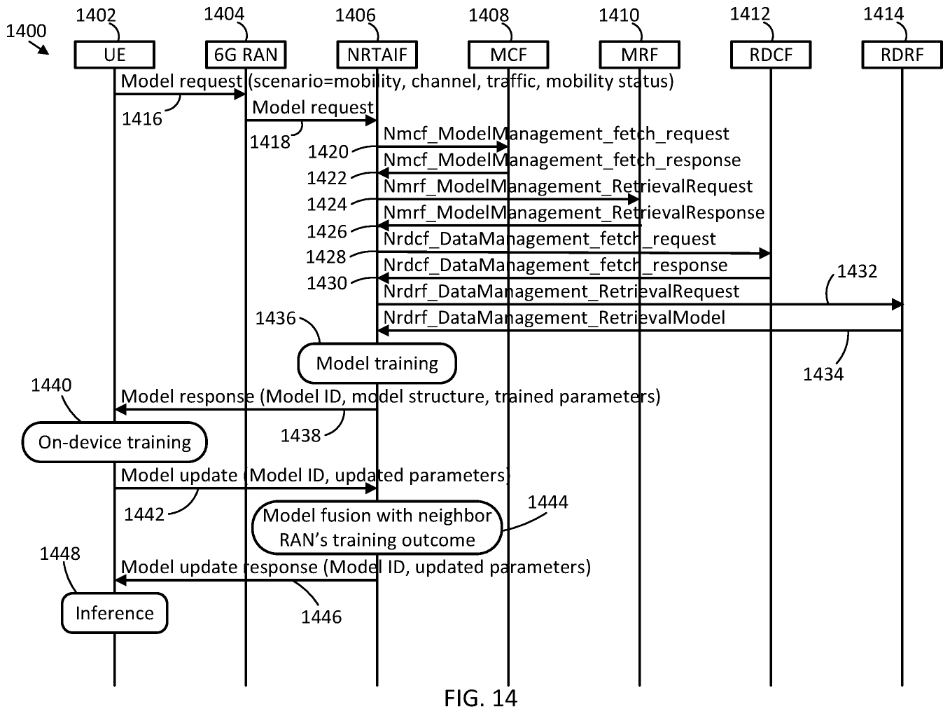

In this example, scenario=mobility, which requires NRTAIF handling. In particular, the scenario of the RAN receiving the model request message and forwarding the model request message to the NRTAIF may be a mobility scenario. FIG. 14 illustrates signaling for an example scenario of mobility.

Based on channel, traffic and mobility status provided by the UE, NRTAIF identifies the model ID of the most suitable model from MCF, and then retrieves such model structure and parameters from MRF based on the model ID. For example, the NRTAIF may query the MCF for information about models stored by the MRF. The NRTAIF may determine the model stored by the MRF that is most suitable for the UE based on the channel, traffic, and/or mobility status indicated by the UE, the most suitable model being determined from the models stored by the MRF. The NRTAIF may further identify a model ID corresponding to the most suitable model from the MCF. The NRTAIF may retrieve the model structure and parameters from the MRF using the model ID.

Based on the scenario (e.g., mobility), NRTAIF identifies the dataset ID of the most suitable dataset from RDCF, and then retrieves such dataset from RDRF based on the dataset ID. For example, the NRTAIF may query the RDCF for information about datasets stored by the RDRF. The NRTAIF may determine the dataset stored by the RDRF that is most suitable for the UE based on the scenario, the most suitable dataset being determined from the datasets stored by the RDRF. The NRTAIF may further identify a dataset ID corresponding to the most suitable dataset from the RDCF. The NRTAIF may retrieve the dataset from the RDRF using the dataset ID.

NRTAIF may perform offline training based on retrieved model and dataset. For example, the NRTAIF may perform training with the model retrieved from the MRF and the dataset retrieved from the RDRF. The NRTAIF may perform the training offline. NRTAIF sends model ID, model structure and trained parameters to UE via model response message. For example, the NRTAIF may provide the model ID retrieved from the MCF, the model structure retrieved from the MRF, and/or the trained parameters resulting from the offline training by the NRTAIF to the UE via a model response message.

The UE performs local training based on received model and local collected data, and then sends the trained parameter and model ID to 6G RAN via model update message, and 6G RAN forwards it to NRTAIF. For example, the UE may implement the model based on the model response message received from the NRTAIF. The UE may perform local training with the implemented model using local data collected by the UE. The UE may transmit a model update message to the RAN that includes the model ID and the parameters produced by the local training. The RAN may forward the model update message to the NRTAIF.

NRTAIF performs model fusion based on the UE reported parameters and neighbor 6G RAN training outcome to achieve loading balancing among these 6G RAN. For example, the NRTAIF may receive trained parameters from multiple UEs and/or multiple RANs. The NRTAIF may fuse the trained parameters received from the multiple UEs and/or multiple RANs. Neighbor 6G RAN training results are fused because it is related to decision of UE mobility. NRTAIF sends the fused model parameters to UE for mobility inference via model update response. For example, the NRTAIF may transmit a model update response that includes the fused model parameters to the UE. The UE may utilize the fused model parameters for mobility inference.

FIG. 14 illustrates an example of AI based mobility signaling in accordance with some embodiments. In particular, FIG. 14 illustrates a signaling chart 1400 that illustrates messages that may be exchanged between a UE and a network for providing an AI/ML model to the UE in accordance with some embodiments. The signals, or some portion thereof, illustrated in the signaling chart 1400 may comprise RRC signals in some embodiments.

The signaling chart 1400 may include a UE 1402. The UE 1402 may include one or more of the features of the UE 546 (FIG. 5), the UE 642 (FIG. 6), the UE 1302 (FIG. 13), and/or the UE 1800 (FIG. 18). The UE 1402 may be connected to a network via a base station (the base station 306 (FIG. 3), the 6G RU element 544 (FIG. 5), and/or the 6G RU element 640 (FIG. 6), and/or the gNB 1900 (FIG. 19)).

The signaling chart 1400 may include a 6G RAN 1404. The 6G RAN 1404 may include one or more of the features of the RAN 402 (FIG. 4), the RAN 502 (FIG. 5), the combined RAN/CN 602 (FIG. 6), and/or the 6G RAN 1304 (FIG. 13).

The signaling chart 1400 may include an NRTAIF 1406. The NRTAIF 1406 may include one or more of the features of the NRTAIF 420 (FIG. 4), the NRTAIF 520 (FIG. 5), and/or the NRTAIF 604 (FIG. 6).

The signaling chart 1400 may include an MCF 1408. The MCF 1408 may include one or more of the features of the MCF 428 (FIG. 4) and/or the MCF 550 (FIG. 5). In other embodiments, the MCF 1408 may comprise a CMCF, where the CMCF includes one or more of the features of the CMCF 612 (FIG. 6).

The signaling chart 1400 may include an MRF 1410. The MRF 1410 may include one or more of the features of the MRF 426 (FIG. 4) and/or the MRF 548 (FIG. 5). In other embodiments, the MRF 1410 may comprise a CMRF, where the CMRF includes one or more of the features of the CMRF 610 (FIG. 6).

The signaling chart 1400 may include an RDCF 1412. The RDCF 1412 may include one or more of the features of the RDCF 414 (FIG. 4), the RDCF 514 (FIG. 5), and/or the RDCF 1312 (FIG. 13). In other embodiments, the RDCF 1412 may comprise a CDCF, where the CDCF may include one or more of the features of the CDCF 614 (FIG. 6).

The signaling chart 1400 may include an RDRF 1414. The RDRF 1414 may include one or more of the features of the RDRF 408 (FIG. 4), the RDRF 508 (FIG. 5), and/or the RDRF 1314 (FIG. 13). In other embodiments, the RDRF 1414 may comprise a CDRF, where the CDRF may include one or more of the features of the CDRF 616 (FIG. 6).

The UE 1402 may determine to request an AI/ML model. The UE 1402 may determine to request the AI/ML model based on movement of the UE 1402 in some embodiments. The UE 1402 may generate and transmit a model request message 1416 to the 6G RAN 1404. The model request message 1416 may be an RRC message. The model request message 1416 may indicate a scenario, a channel, traffic, and/or a mobility status related to the UE 1402. In this instance, the model request message 1416 may indicate that the scenario is mobility.

The 6G RAN 1404 may receive the model request message 1416 from the UE 1402. The 6G RAN 1404 may transmit a model request message 1418 to the NRTAIF 1406. In some embodiments, the model request message 1418 may be the same as the model request message 1416, where the 6G RAN 1404 transmitting the model request message 1418 comprises forwarding the model request message 1416. In other embodiments, the 6G RAN 1404 may generate the model request message 1418 based on the model request message 1416. For example, the 6G RAN 1404 may generate the model request message 1418 as a copy of the model request message 1416 or may generate the model request message 1418 to include less or more parameters than the model request message 1416. In some of these embodiments, the model request message 1418 may include the channel, the traffic, and/or the mobility status related to the UE 1402.

The NRTAIF 1406 may receive the model request message 1418 from the 6G RAN 1404. The NRTAIF 1406 may determine the scenario, the channel, the traffic, and/or the mobility status related to the UE 1402 from the model request message 1418. The NRTAIF 1406 may transmit a model management fetch request 1420 to the MCF 1408. The model management fetch request 1420 may request information regarding AI/ML models stored by the MRF 1410.

The MCF 1408 may receive the model management fetch request 1420 from the NRTAIF 1406. The MCF 1408 may determine that the NRTAIF 1406 is requesting information regarding AI/ML models stored by the MRF 1410. The MCF 1408 may determine information regarding the AI/ML models stored by the MRF 1410. The information regarding the AI/ML models may include model IDs corresponding to each of the AI/ML models as well as other information related to the AI/ML models. The MCF 1408 may generate a model management fetch response message 1422. The model management fetch response message 1422 may include the information regarding the AI/ML models stored by the MRF 1410. The MCF 1408 may transmit the model management fetch response message 1422 to the NRTAIF 1406.

The NRTAIF 1406 may receive the model management fetch response message 1422 from the MCF 1408. The NRTAIF 1406 may identify the information regarding the AI/ML models stored by the MRF 1410 from the model management fetch response message 1422. The NRTAIF 1406 may determine an AI/ML model that is most suitable for the UE 1402 based on the information regarding the AI/ML models, the channel indicated by the model request message 1418, the traffic indicated by the model request message 1418, and/or the mobility status indicated by the model request message 1418. The NRTAIF 1406 may further determine a model ID corresponding to the AI/ML model that is most suitable for the UE 1402.

The NRTAIF 1406 may generate a model management retrieval request message 1424. The model management retrieval request message 1424 may indicate the model ID corresponding to the AI/ML model that was determined to be most suitable for the UE 1402. The model management retrieval request message 1424 may further indicate that the NRTAIF 1406 is requesting the AI/ML model corresponding to the model ID. The NRTAIF 1406 may transmit the model management retrieval request message 1424 to the MRF 1410.

The MRF 1410 may receive the model management retrieval request message 1424 from the NRTAIF 1406. The MRF 1410 may identify the model ID and determine that the model management retrieval request message 1424 is requesting that the AI/ML model corresponding to the model ID be provided to the NRTAIF 1406. The MRF 1410 may generate a model management retrieval response message 1426. In the instance where the MRF 1410 has the AI/ML model corresponding to the model ID stored and the MRF 1410 can identify the AI/ML model based on the model ID, the model management retrieval response message 1426 may include the AI/ML model. In the instance where the MRF 1410 is unable to provide the AI/ML model corresponding to the model ID, the model management retrieval response message 1426 may indicate that the MRF 1410 is unable to provide the AI/ML model. The MRF 1410 may transmit the model management retrieval response message 1426 to the NRTAIF 1406.

The NRTAIF 1406 may receive the model management retrieval response message 1426 from the MRF 1410. The NRTAIF 1406 may identify and store the AI/ML model included in the model management retrieval response message 1426.

The NRTAIF 1406 may generate a data management fetch request message 1428. The data management fetch request message 1428 may request information regarding datasets stored by the RDRF 1414. The NRTAIF 1406 may transmit the data management fetch request message 1428 to the RDCF 1412.

The RDCF 1412 may receive the data management fetch request message 1428 from the NRTAIF 1406. The RDCF 1412 may determine that the NRTAIF 1406 is requesting information regarding datasets stored by the RDRF 1414. The RDCF 1412 may determine information regarding the datasets stored by the RDRF 1414. The information regarding the datasets may include dataset IDs corresponding to each of the datasets as well as other information related to the datasets. The RDCF 1412 may generate a data management fetch response message 1430. The data management fetch response message 1430 may include the information regarding the datasets stored by the RDRF 1414. The RDCF 1412 may transmit the data management fetch response message 1430 to the NRTAIF 1406.

The NRTAIF 1406 may receive the data management fetch response message 1430 from the RDCF 1412. The NRTAIF 1406 may identify the information regarding the datasets stored by the RDRF 1414 from the data management fetch response message 1430. The NRTAIF 1406 may determine a dataset that is most suitable for the UE 1402 based on the information regarding the datasets and/or the scenario indicated by the UE 1402. The NRTAIF 1406 may further determine a dataset ID corresponding to the dataset that is most suitable for the UE 1402.

The NRTAIF 1406 may generate a data management retrieval request message 1432. The data management retrieval request message 1432 may indicate the dataset ID corresponding to the dataset that was determined to be most suitable for the UE 1402. The data management retrieval request message 1432 may further indicate that the NRTAIF 1406 is requesting the dataset corresponding to the dataset ID. The NRTAIF 1406 may transmit the data management retrieval request message 1432 to the RDRF 1414.

The RDRF 1414 may receive the data management retrieval request message 1432 from the NRTAIF 1406. The RDRF 1414 may identify the dataset ID and determine that the data management retrieval request message 1432 is requesting the dataset corresponding to the dataset ID be provided to the NRTAIF 1406. The RDRF 1414 may generate a data management retrieval model message 1434. In the instance where the RDRF 1414 has the dataset corresponding to the dataset ID stored and the RDRF 1414 can identify the dataset based on the dataset ID, the data management retrieval model message 1434 may include the dataset. In the instance where the RDRF 1414 is unable to provide the dataset corresponding to the dataset ID, the data management retrieval model message 1434 may indicate that the RDRF 1414 is unable to provide the dataset. The RDRF 1414 may transmit the data management retrieval model message 1434 to the NRTAIF 1406.

The NRTAIF 1406 may receive the data management retrieval model message 1434 from the RDRF 1414. The NRTAIF 1406 may identify and store the dataset included in the data management retrieval model message 1434.

In 1436, the NRTAIF 1406 may perform model training. In particular, the NRTAIF 1406 may perform model training of the model received in the model management retrieval response message 1426 with the dataset received in the data management retrieval model message 1434. The NRTAIF 1406 may perform the model training in an offline training approach. The model training may result in the model being trained for utilization by the UE 1402.

The NRTAIF 1406 may generate a model response message 1438. The model response message 1438 may include the trained model produced in the model training of 1436. For example, the model response message 1438 may include a model ID corresponding to the trained model, a model structure corresponding to the trained model, and/or one or more parameters for the trained model. The NRTAIF 1406 may transmit the model response message 1438 to the UE 1402 (such as transmitting the model response message 1438 from the NRTAIF 1406 through the 6G RAN 1404 to the UE 1402).

The UE 1402 may receive the model response message 1438 from the NRTAIF 1406. The UE 1402 may determine the trained AI/ML model to be utilized by the UE 1402 based on the model response message 1438. In 1440, the UE 1402 may perform on-device training with the received trained AI/ML model. For example, the UE 1402 may collect data during operation and utilize the collected data to further train the trained AI/ML model. The data collected by the UE 1402 may be data collected prior to implementation of the received, trained AI/ML model and/or data collected while the received/trained AI/ML model is implemented by the UE 1402. The on-device training performed by the UE 1402 may produce updated parameters related to the AI/ML model.

The UE 1402 may generate a model update message 1442. The model update message 1442 may be generated based on the on-device training performed in 1440. The model update message 1442 may include the model ID corresponding to the AI/ML model (as received in the model response message 1438) and/or the updated parameters produced by the on-device training performed in 1440. The UE 1402 may transmit the model update message 1442 to the NRTAIF 1406 (such as transmitting the model update message 1442 from the UE 1402 through the 6G RAN 1404 to the NRTAIF 1406).

The NRTAIF 1406 may receive the model update message 1442. The NRTAIF 1406 may identify the model ID and the updated parameters from the model update message 1442. Further, the NRTAIF 1406 may determine the model based on the model ID. The NRTAIF 1406 may also receive other sets of updated parameters related to the model from one or more other UEs and/or one or more other RANs (which may be referred to as neighbor RANs). In 1444, the NRTAIF 1406 may perform fusion of the updated parameters from the UE 1402 with the sets of updated parameters from the one or more other UEs and/or the one or more other RANs. The fusion performed by the NRTAIF 1406 may result in fused updated parameters for the AI/ML model.

The NRTAIF 1406 may generate a model update response message 1446. The model update response message 1446 may include the fused updated parameters produced by the NRTAIF 1406 and/or the model ID corresponding to the AI/ML model. The NRTAIF 1406 may transmit the model update response message 1446 to the UE 1402 (such as transmitting the model update response message 1446 from the NRTAIF 1406 through the 6G RAN 1404 to the UE 1402).

The UE 1402 may receive the model update response message 1446 from the NRTAIF 1406. The UE 1402 may determine the fused updated parameters for the AI/ML model from the model update response message 1446. In some embodiments, the UE 1402 may perform an inference in 1448 for the AI/ML model based on the fused updated parameters. The UE 1402 may implement the AI/ML model based on the inference.

While the signaling chart 1400 illustrates one embodiment, it should be understood that more or less messages may be included in other embodiments. Further, one or more of the messages may be transmitted in a different order in other embodiments.

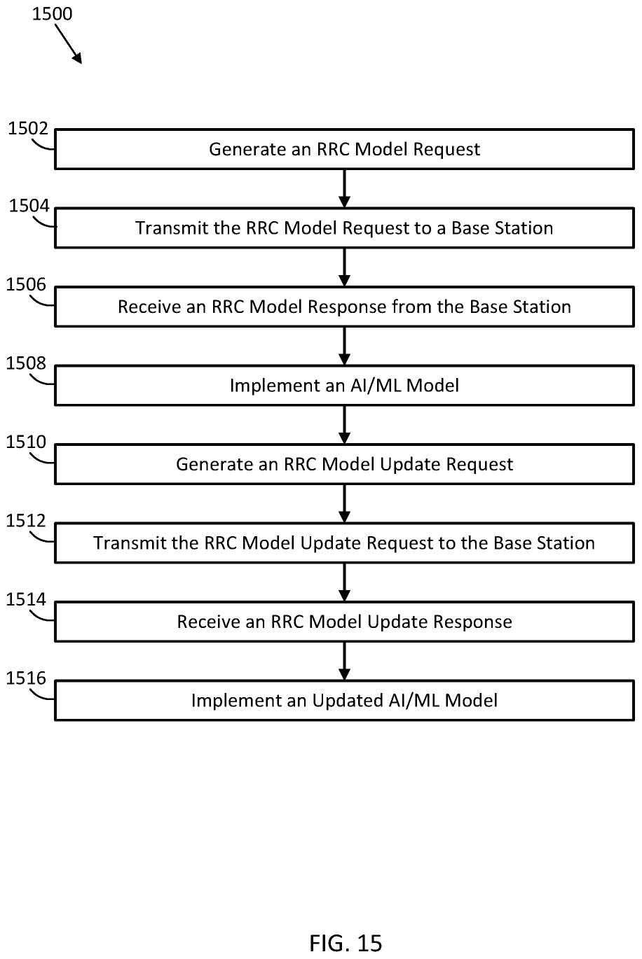

FIG. 15 illustrates an example procedure 1500 of operating a user equipment in accordance with some embodiments. For example, the procedure 1500 may be performed by a UE, such as the UE 546 (FIG. 5), the UE 642 (FIG. 6), and/or the UE 1800 (FIG. 18).

The procedure 1500 may include generating an RRC model request in 1502. For example, the UE may generate an RRC model request that indicates a scenario, a channel, traffic, or a mobility status related to the UE. In some embodiments, the RRC model request may include one or more of the features of the model request message 1316 (FIG. 13) and/or the model request message 1416 (FIG. 14). In some embodiments, the RRC model request may indicate a scenario that comprises CSI compression related to the UE or mobility related to the UE. Further, the traffic may comprise a traffic type related to the UE and a traffic loading related to the UE in some embodiments. In some embodiments, the mobility status may comprise mobility speed related to the UE or mobility parameters related to the UE.

The procedure 1500 may include transmitting the RRC model request to a base station in 1504. For example, the UE may transmit the RRC model to a base station. The base station 1504 may include one or more of the features of the 6G RU element 544 (FIG. 5) and/or the 6G RU element 640 (FIG. 6). In some embodiments, the base station may be a connection point for a RAN and may include one or more of the features of the 6G RAN 1304 (FIG. 13) and/or the 6G RAN 1404 (FIG. 14).

The procedure 1500 may include receiving an RRC model response from the base station in 1506. For example, the UE may receive an RRC model response from the base station with an indication of an AI/ML model for the UE. In some embodiments, the RRC model response may include a model ID, a model structure, or parameters that indicate the AI/ML model to be implemented by the UE. In some embodiments, the indication of the AI/ML model is supplied by an RMRF (such as the RMRF 412 (FIG. 4), the RMRF 512 (FIG. 5), and/or the RMRF 1310 (FIG. 13)) included within a RAN infrastructure (such as the RAN 402 (FIG. 4), and/or the RAN 502 (FIG. 5)) corresponding to the base station.

The procedure 1500 may include implementing an AI/ML model in 1508. For example, the UE may implement the AI/ML model indicated by the RRC model response.

The procedure 1500 may include generating an RRC model update request in 1510. For example, the UE may generate an RRC model update request for requesting an updated AI/ML model for the UE. The model update request may indicate a model ID corresponding to the AI/ML model. The model update request may include one or more of the features of the model update message 1442 (FIG. 14). In some embodiments, the RRC model update request may further indicate one or more trained model parameters related to the UE. In some embodiments, 1510 may be omitted.

The procedure 1500 may include transmitting the RRC model update request to the base station in 1512. For example, the UE may transmit the RRC model update request to the base station. In some embodiments, 1512 may be omitted.

The procedure 1500 may include receiving an RRC model update response in 1514. For example, the UE may receive an RRC model update response from the base station that indicates the updated AI/ML model for the UE. The RRC model update response may include one or more of the features of the model update response message 1446 (FIG. 14). In some embodiments, 1514 may be omitted.

The procedure 1500 may include implementing the updated AI/ML model in 1516. For example, the UE may implement the updated AI/ML model indicated by the RRC model update response. In some embodiments, 1516 may be omitted.

While FIG. 15 may suggest an order of operations of the procedure 1500 in accordance with some embodiments, it should be understood that the operations may be performed in different orders and/or one or more of the operations may be performed concurrently in other embodiments. Further, one or more of the operations of the procedure 1500 may be omitted and/or one or more additional operations may be included in the procedure 1500 in other embodiments.

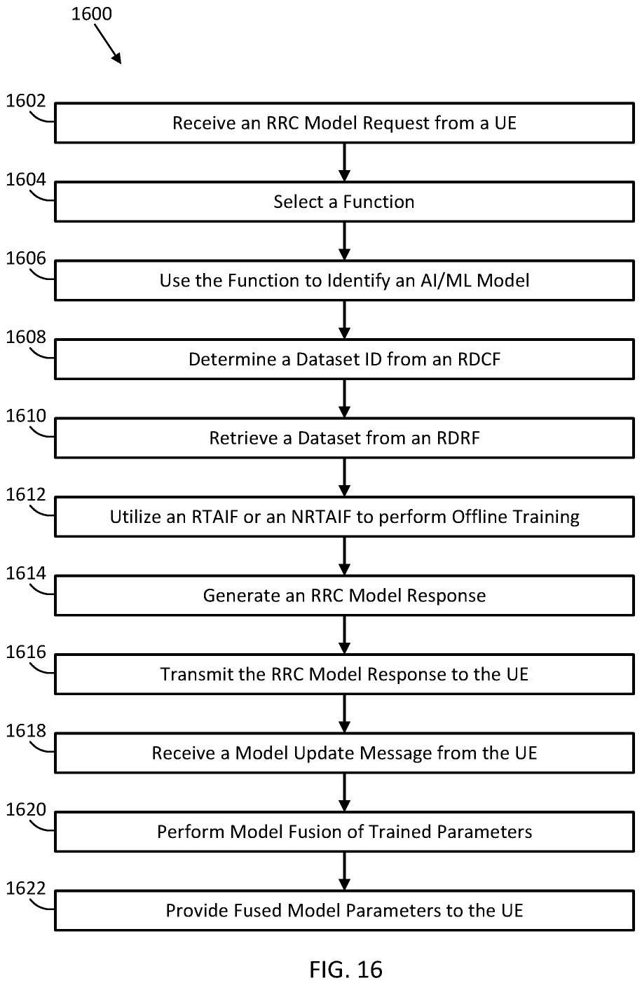

FIG. 16 illustrates an example procedure 1600 of operating a base station in accordance with some embodiments. For example, the procedure 1600 may be performed by base station, such as the 6G RU element 544 (FIG. 5), the 6G RU element 640 (FIG. 6), the 6G RAN 1304 (FIG. 13), the 6G RAN 1404 (FIG. 14), and/or the gNB 1900 (FIG. 19).

The procedure 1600 may include receiving an RRC model request from a UE in 1602. For example, the base station may receive an RRC model request from a UE. The RRC model request may include one or more of the features of the model request message 1316 (FIG. 13) and/or the model request message 1416 (FIG. 14). The RRC model request may indicate a scenario, a channel, traffic, or a mobility status related to the UE.

The procedure 1600 may include selecting a function in 1604. For example, the base station may select a function based on the scenario. The function may be an RTAIF or an NRTAIF.

The procedure 1600 may include using the function to identify an AI/ML model in 1606. For example, the base station may use the function to identify an AI/ML model for the UE based on the channel, the traffic, or the mobility status indicated by the RRC model request.

In some embodiments, identifying the AI/ML model may include determining a plurality of AI/ML models stored by an RMRF (such as the RMRF 412 (FIG. 4), the RMRF 512 (FIG. 5), and/or the RMRF 1310 (FIG. 13)) or an MRF (such as the MRF 426 (FIG. 4), the MRF 548 (FIG. 5), and/or the MRF 1410 (FIG. 14)). Identifying the AI/ML model may further include determining the AI/ML model from the plurality of AI/ML models based on the AI/ML model being determined to be most suitable for the UE from the plurality of AI/ML models based on the channel, the traffic, or the mobility status. In some of these embodiments, the plurality of AI/ML models are stored by the RMRF and the RMRF is located within a RAN infrastructure (such as the RAN 402 (FIG. 4) and/or the RAN 502 (FIG. 5)) corresponding to the base station. Further, the RAN infrastructure may be implemented as an SBA in some of these embodiments.

The procedure 1600 may include determining a dataset ID from an RDCF in 1608. For example, the base station may determine, using the RTAIF or the NRTAIF, a data set ID from an RDCF (such as the RDCF 414 (FIG. 4), the RDCF 514 (FIG. 5), the RDCF 1312 (FIG. 13), and/or the RDCF 1412 (FIG. 14)) corresponding to a dataset suitable for the UE based on the scenario. In some embodiments, 1608 may be omitted.

The procedure 1600 may include retrieving a dataset from an RDRF in 1610. For example, the base station may retrieve, utilizing the dataset ID, the dataset from an RDRF (such as the RDRF 408 (FIG. 4), the RDRF 508 (FIG. 5), the RDRF 1314 (FIG. 13), and/or the RDRF 1414 (FIG. 14)). In some embodiments, 1610 may be omitted.

The procedure 1600 may include utilizing an RTAIF or an NRTAIF to perform offline training in 1612. For example, the base station may utilize the RTAIF or the NRTAIF to perform offline training of the AI/ML model. The dataset retrieved in 1610 may be utilized for the offline training of the AI/ML model in some embodiments. In some embodiments, 1612 may be omitted.

The procedure 1600 may include generating an RRC model response in 1614. For example, the base station may generate an RRC model response that indicates a model ID corresponding to the AI/ML model. The RRC model response may include one or more of the features of the model response message 1348 (FIG. 13) and/or the model response message 1438 (FIG. 14). The RRC model response may further indicate a model structure for the AI/ML model and one or more model parameters for the AI/ML model in some embodiments.

The procedure 1600 may include transmitting the RRC model response to the UE in 1616. For example, the base station may transmit the RRC model response to the UE.

The procedure 1600 may include receiving a model update message from the UE in 1618. For example, the base station may receive a model update message from the UE. The model update message may include one or more of the features of the model update message 1442 (FIG. 14). The model update message may indicate trained parameters and the model ID. In some embodiments, 1618 may be omitted.

The procedure 1600 may include performing model fusion of trained parameters in 1620. For example, the base station may perform, using the NRTAIF, model fusion of the trained parameters with one or more sets of trained parameters provided by one or more neighboring RANs to generate fused model parameters. In some embodiments, 1620 may be omitted.

The procedure 1600 may include providing fused model parameters to the UE in 1622. For example, the base station may provide the fused model parameters to the UE. In some embodiments, 1622 may be omitted.

While FIG. 16 may suggest an order of operations of the procedure 1600 in accordance with some embodiments, it should be understood that the operations may be performed in different orders and/or one or more of the operations may be performed concurrently in other embodiments. Further, one or more of the operations of the procedure 1600 may be omitted and/or one or more additional operations may be included in the procedure 1600 in other embodiments.

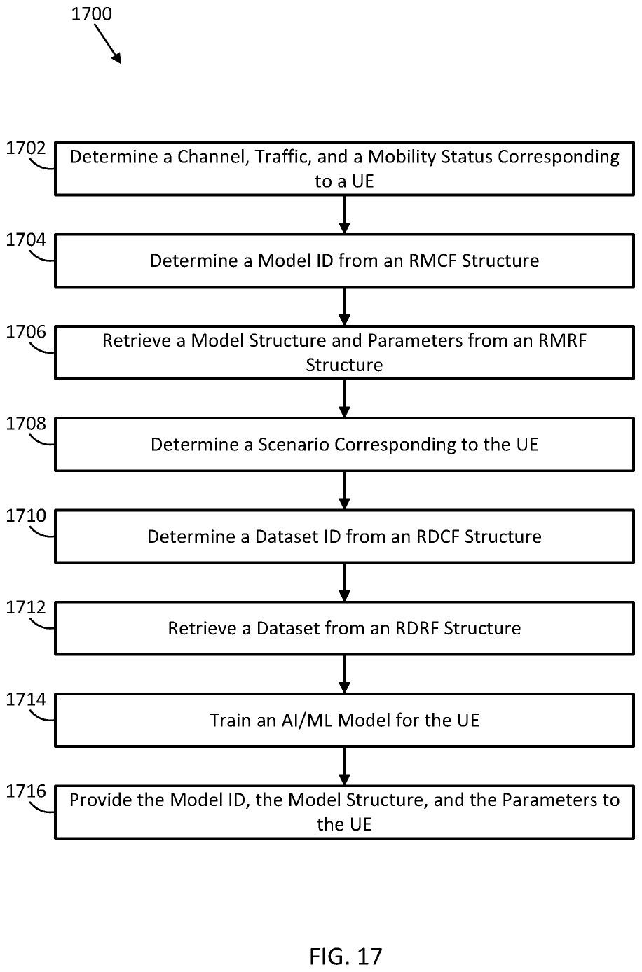

FIG. 17 illustrates a procedure 1700 that may be performed by an RTAIF structure or an NRTAIF structure in accordance with some embodiments. For example, the procedure 1700 may be performed by an RTAIF structure (such as the RTAIF 540 (FIG. 5), the RTAIF 636 (FIG. 6), and/or the RTAIF 1306 (FIG. 13)) in some embodiments. The procedure 1700 may be performed by an NRTAIF structure (such as the NRTAIF 520 (FIG. 5), the NRTAIF 604 (FIG. 6), and/or the NRTAIF 1406 (FIG. 14)) in some embodiments.

The procedure 1700 may be performed as part of a RAN infrastructure, such as the RAN 402 (FIG. 4), the RAN 502 (FIG. 5), and/or the combined RAN/CN 602 (FIG. 6). The RAN infrastructure may include an RMRF structure to store AI/ML models. The RMRF may include one or more of the features of the RMRF 412 (FIG. 4), the RMRF 512 (FIG. 5), and/or the RMRF 1310 (FIG. 13). In some embodiments, the RMRF may be merged with an MRF (such as the MRF 426 (FIG. 4), the MRF 548 (FIG. 5), and/or the MRF 1410 (FIG. 14)) as part of a CMRF (such as the CMRF 610 (FIG. 6)).

The RAN infrastructure may include an RMCF structure to manage the AI/ML models. The RMCF structure may include one or more of the features of the RMCF 418 (FIG. 4), the RMCF 518 (FIG. 5), and/or the RMCF 1308 (FIG. 13). The RMRF structure and the RMCF structure may be arranged in an SBA and addressable via HTTP signaling. In some embodiments, the RMCF structure may be merged with an MCF (such as the MCF 428 (FIG. 4), the MCF 550 (FIG. 5), and/or the MCF 1408 (FIG. 14)) as part of a CMCF structure (such as the CMCF 612 (FIG. 6)).

The RAN infrastructure may include a base station coupled to the RMRF structure and the RMCF structure. The base station may include one or more of the features of the 6G RU element 544 (FIG. 5), the 6G RU element 640 (FIG. 6), the 6G RAN 1304 (FIG. 13), the 6G RAN 1404 (FIG. 14), and/or the gNB 1900 (FIG. 19). The base station may communicate with one or more UEs (such as the UE 546 (FIG. 5), the UE 642 (FIG. 6), the UE 1302 (FIG. 13), the UE 1402 (FIG. 14), and/or the UE 1800 (FIG. 18)) to share AI/ML models.

The RAN infrastructure may include an RTAIF structure and/or an NRTAIF structure coupled to the RMRF structure and the RMCF structure. The RTAIF structure may include one or more of the features of the RTAIF 540 (FIG. 5), the RTAIF 636 (FIG. 6), and/or the RTAIF 1306 (FIG. 13). The NRTAIF structure may include one or more of the features of the NRTAIF 520 (FIG. 5), the NRTAIF 604 (FIG. 6), and/or the NRTAIF 1406 (FIG. 14). In some embodiments, the RTAIF and/or the NRTAIF may be omitted from the RAN infrastructure.

The RAN infrastructure may include an RDRF structure coupled to the RMRF structure and the RMCF structure in the SBA. The RDRF structure may include one or more of the features of the RDRF 408 (FIG. 4), the RDRF 508 (FIG. 5), the RDRF 1314 (FIG. 13), and/or the RDRF 1414 (FIG. 14). The RDRF structure may store data to be utilized for training the AI/ML models. In some embodiments, the RDRF structure may be omitted from the RAN infrastructure.

The RAN infrastructure may include an RDCF structure coupled to the RMRF structure, the RMCF structure, and the RDRF structure in the SBA. The RDCF structure may include one or more of the features of the RDCF 414 (FIG. 4), the RDCF 514 (FIG. 5), RDCF 1312 (FIG. 13), and/or the RDCF 1412 (FIG. 14). The RDCF structure may manage data stored by the RDRF structure. In some embodiments, the RDCF structure may be omitted from the RAN infrastructure.

The procedure 1700 may include determining a channel, traffic, and a mobility status corresponding to a UE in 1702. For example, the RTAIF or the NRTAIF may determine a channel, traffic, and a mobility status corresponding to a UE based on a received RRC model request. The RRC model request may include one or more of the features of the model request message 1318 (FIG. 13) and/or the model request message 1418 (FIG. 14).

The procedure 1700 may include determining a model ID from an RMCF structure in 1704. For example, the RTAIF or the NRTAIF may determine a model ID from the RMCF structure corresponding to an AI/ML model of the AI/ML models stored by the RMCF. The AI/ML model may be determined to be suitable for the UE based on the channel, the traffic, and the mobility status.

The procedure 1700 may include retrieving a model structure and parameters from an RMRF structure in 1706. For example, the RTAIF or the NRTAIF may retrieve a model structure and parameters from the RMRF structure for the UE based on the model ID.

The procedure 1700 may include determining a scenario corresponding to the UE in 1708. For example, the RTAIF or the NRTAIF may determine a scenario corresponding to a UE based on a received RRC model request. The RRC model request may include one or more of the features of the model request message 1318 (FIG. 13) and/or the model request message 1418 (FIG. 14).

The procedure 1700 may include determining a dataset ID from an RDCF structure in 1710. For example, the RTAIF or the NRTAIF may determine a dataset ID from the RDCF structure for the UE based on the scenario.

The procedure 1700 may include retrieving a dataset from an RDRF structure in 1712. For example, the RTAIF or the NRTAIF may retrieve a dataset from the RDRF structure based on the dataset ID.

The procedure 1700 may include training an AI/ML model for the UE in 1714. For example, the RTAIF or the NRTAIF may train an AI/ML model for the UE utilizing the dataset.

The procedure 1700 may include providing the model Id, the model structure, and the parameters to the UE in 1716. For example, the RTAIF or the NRTAIF may provide the model ID, the model structure, and the parameters to the UE.

While FIG. 17 may suggest an order of operations of the procedure 1700 in accordance with some embodiments, it should be understood that the operations may be performed in different orders and/or one or more of the operations may be performed concurrently in other embodiments. Further, one or more of the operations of the procedure 1700 may be omitted and/or one or more additional operations may be included in the procedure 1700 in other embodiments.

FIG. 18 illustrates an example UE 1800 in accordance with some embodiments. The UE 1800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1800 may be a RedCap UE or NR-Light UE.

The UE 1800 may include processors 1804, RF interface circuitry 1808, memory/storage 1812, user interface 1816, sensors 1820, driver circuitry 1822, power management integrated circuit (PMIC) 1824, antenna structure 1826, and battery 1828. The components of the UE 1800 may be implemented as integrated circuits (ICs), portions thereof, discrete electronic devices, or other modules, logic, hardware, software, firmware, or a combination thereof. The block diagram of FIG. 18 is intended to show a high-level view of some of the components of the UE 1800. However, some of the components shown may be omitted, additional components may be present, and different arrangement of the components shown may occur in other implementations.

The components of the UE 1800 may be coupled with various other components over one or more interconnects 1832, which may represent any type of interface, input/output, bus (local, system, or expansion), transmission line, trace, optical connection, etc. that allows various circuit components (on common or different chips or chipsets) to interact with one another.

The processors 1804 may include processor circuitry such as, for example, baseband processor circuitry (BB) 1804A, central processor unit circuitry (CPU) 1804B, and graphics processor unit circuitry (GPU) 1804C. The processors 1804 may include any type of circuitry or processor circuitry that executes or otherwise operates computer-executable instructions, such as program code, software modules, or functional processes from memory/storage 1812 to cause the UE 1800 to perform operations as described herein. For example, the processors 1804 may include interface circuitry coupled with the BB 1804A, the CPU 1804B, and/or the GPU 1804C that can communicatively couple the BB 1804A, the CPU 1804B, and/or the GPU 1804C to the memory/storage 1812 for retrieval of the computer-executable instructions (among other operations) from the memory/storage 1812 for execution.

In some embodiments, the baseband processor circuitry 1804A may access a communication protocol stack 1836 in the memory/storage 1812 to communicate over a 3GPP compatible network. In general, the baseband processor circuitry 1804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1808.

The baseband processor circuitry 1804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1812 may include one or more non-transitory, computer-readable media that includes instructions (for example, communication protocol stack 1836) that may be executed by one or more of the processors 1804 to cause the UE 1800 to perform various operations described herein. The memory/storage 1812 include any type of volatile or non-volatile memory that may be distributed throughout the UE 1800. In some embodiments, some of the memory/storage 1812 may be located on the processors 1804 themselves (for example, L1 and L2 cache), while other memory/storage 1812 is external to the processors 1804 but accessible thereto via a memory interface. The memory/storage 1812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1808 may include transceiver circuitry and radio frequency front module (RFEM) that allows the UE 1800 to communicate with other devices over a radio access network. The RF interface circuitry 1808 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1826 and proceed to filter and amplify (with a low-noise amplifier) the signal. The signal may be provided to a receiver of the transceiver that down-converts the RF signal into a baseband signal that is provided to the baseband processor of the processors 1804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1826.

In various embodiments, the RF interface circuitry 1808 may be configured to transmit/receive signals in a manner compatible with NR access technologies.

The antenna 1826 may include antenna elements to convert electrical signals into radio waves to travel through the air and to convert received radio waves into electrical signals. The antenna elements may be arranged into one or more antenna panels. The antenna 1826 may have antenna panels that are omnidirectional, directional, or a combination thereof to enable beamforming and multiple input, multiple output communications. The antenna 1826 may include microstrip antennas, printed antennas fabricated on the surface of one or more printed circuit boards, patch antennas, phased array antennas, etc. The antenna 1826 may have one or more panels designed for specific frequency bands including bands in FR1 or FR2.

The user interface circuitry 1816 includes various input/output (I/O) devices designed to enable user interaction with the UE 1800. The user interface 1816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1800.

The sensors 1820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1822 may include software and hardware elements that operate to control particular devices that are embedded in the UE 1800, attached to the UE 1800, or otherwise communicatively coupled with the UE 1800. The driver circuitry 1822 may include individual drivers allowing other components to interact with or control various input/output (I/O) devices that may be present within, or connected to, the UE 1800. For example, driver circuitry 1822 may include a display driver to control and allow access to a display device, a touchscreen driver to control and allow access to a touchscreen interface, sensor drivers to obtain sensor readings of sensor circuitry 1820 and control and allow access to sensor circuitry 1820, drivers to obtain actuator positions of electro-mechanic components or control and allow access to the electro-mechanic components, a camera driver to control and allow access to an embedded image capture device, audio drivers to control and allow access to one or more audio devices.

The PMIC 1824 may manage power provided to various components of the UE 1800. In particular, with respect to the processors 1804, the PMIC 1824 may control power-source selection, voltage scaling, battery charging, or DC-to-DC conversion.

In some embodiments, the PMIC 1824 may control, or otherwise be part of, various power saving mechanisms of the UE 1800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1800 may power down for brief intervals of time and thus save power. If there is no data traffic activity for an extended period of time, then the UE 1800 may transition off to an RRC_Idle state, where it disconnects from the network and does not perform operations such as channel quality feedback, handover, etc. The UE 1800 goes into a very low power state and it performs paging where again it periodically wakes up to listen to the network and then powers down again. The UE 1800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1828 may power the UE 1800, although in some examples the UE 1800 may be mounted deployed in a fixed location, and may have a power supply coupled to an electrical grid. The battery 1828 may be a lithium ion battery, a metal-air battery, such as a zinc-air battery, an aluminum-air battery, a lithium-air battery, and the like. In some implementations, such as in vehicle-based applications, the battery 1828 may be a typical lead-acid automotive battery.

FIG. 19 illustrates an example gNB 1900 in accordance with some embodiments. The gNB 1900 may include processors 1904, RF interface circuitry 1908, core network (CN) interface circuitry 1912, memory/storage circuitry 1916, and antenna structure 1926.

The components of the gNB 1900 may be coupled with various other components over one or more interconnects 1928.

The processors 1904, RF interface circuitry 1908, memory/storage circuitry 1916 (including communication protocol stack 1910), antenna structure 1926, and interconnects 1928 may be similar to like-named elements shown and described with respect to FIG. 18.

The CN interface circuitry 1912 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1900 via a fiber optic or wireless backhaul. The CN interface circuitry 1912 may include one or more dedicated processors or FPGAs to communicate using one or more of the aforementioned protocols. In some implementations, the CN interface circuitry 1912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE) comprising generating a radio resource control (RRC) model request that indicates a scenario, a channel, traffic, or a mobility status related to the UE, transmitting the RRC model request to a base station, receiving an RRC model response from the base station with an indication of an artificial intelligence/machine learning (AI/ML) model for the UE, and implementing the AI/ML model indicated by the RRC model response.

Example 2 may include the method of example 1, wherein the RRC model response includes a model identifier (ID), a model structure, or parameters that indicate the AI/ML model to be implemented by the UE.

Example 3 may include the method of example 1, wherein the indication of the AI/ML model is supplied by a radio access network repository function (RMRF) included within a radio access network (RAN) infrastructure corresponding to the base station.

Example 4 may include the method of example 1, wherein the RRC model request indicates a scenario that comprises channel state information (CSI) compression related to the UE or mobility related to the UE.

Example 5 may include the method of example 1, wherein the RRC model request indicates traffic, and wherein the traffic comprises a traffic type related to the UE and a traffic loading related to the UE.

Example 6 may include the method of example 1, wherein the RRC model request indicates a mobility status, and wherein the mobility status comprises mobility speed related to the UE or mobility parameters related to the UE.

Example 7 may include the method of example 1, wherein the method further comprises generating an RRC model update request for requesting an updated AI/ML model for the UE, the RRC model update request indicating a model identifier (ID) corresponding to the AI/ML model, transmitting the RRC model update request to the base station, receiving an RRC model update response from the base station that indicates the updated AI/ML model for the UE, and implementing the updated AI/ML model indicated by the RRC model update response.

Example 8 may include the method of example 7, wherein the RRC model update request further indicates one or more trained model parameters related to the UE.

Example 9 may include a method of operating a base station comprising receiving a radio resource control (RRC) model request from a user equipment (UE), the RRC model request indicating a scenario, a channel, traffic, or a mobility status related to the UE, selecting a function based on the scenario, the function being a real-time artificial intelligence function (RTAIF) or a non real-time artificial intelligence function (NRTAIF), using the function to identify an artificial intelligence/machine learning (AI/ML) model for the UE based on the channel, the traffic, or the mobility status indicated by the RRC model request, generating an RRC model response that indicates a model identifier (ID) corresponding to the AI/ML model, and transmitting the RRC model response to the UE.

Example 10 may include the method of example 9, wherein identifying the AI/ML model comprises determining a plurality of AI/ML models stored by a radio access network model repository function (RMRF) or a model repository function (MRF), and determining the AI/ML model from the plurality of AI/ML models based on the AI/ML model being determined to be most suitable for the UE from the plurality of AI/ML models based on the channel, the traffic, or the mobility status.

Example 11 may include the method of example 10, wherein the plurality of AI/ML models are stored by the RMRF, and wherein the RMRF is located within a radio access network (RAN) infrastructure corresponding to the base station.

Example 12 may include the method of example 11, wherein the RAN infrastructure is implemented as a service based system architecture.

Example 13 may include the method of example 9 further comprising utilizing the RTAIF or the NRTAIF to perform offline training of the AI/ML model.

Example 14 may include the method of example 13 further comprising determining, using the RTAIF or the NRTAIF, a dataset identifier (ID) from a radio access network data coordination function (RDCF) corresponding to a dataset suitable for the UE based on the scenario, and retrieving, utilizing the dataset ID, the dataset from a radio access network data repository function (RDRF), the dataset utilized for the offline training of the AI/ML model.

Example 15 may include the method of example 9, wherein the RRC model response further indicates a model structure for the AI/ML model and one or more model parameters for the AI/ML model.

Example 16 may include the method of example 9 further comprising receiving a model update message from the UE, the model update message indicating trained parameters and the model ID, performing, using the NRTAIF, model fusion of the trained parameters with one or more sets of trained parameters provided by one or more neighboring radio access networks (RANs) to generate fused model parameters, and providing the fused model parameters to the UE.

Example 17 may include a radio access network (RAN) infrastructure comprising a radio access network model repository function (RMRF) structure to store artificial intelligence/machine learning (AI/ML) models, a radio access network model coordination function (RMCF) structure to manage the AI/ML models, the RMRF structure and the RMCF structure arranged in a service based system architecture and addressable via hypertext transfer protocol (HTTP) signaling, and a base station coupled to the RMRF structure and the RMCF structure, the base station to communicate with one or more user equipments (UEs) to share the AI/ML models.

Example 18 may include the RAN infrastructure of example 17 further comprising a real-time artificial intelligence function (RTAIF) structure or a non real-time artificial intelligence function (NRTAIF) structure coupled to the RMRF structure and the RMCF structure, the RTAIF structure or the NRTAIF structure to determine a channel, traffic, and a mobility status corresponding to a UE based on a received RRC model request, determine a model identifier (ID) from the RMCF structure corresponding to an AI/ML model of the AI/ML models, the AI/ML model determined to be suitable for the UE based on the channel, the traffic, and the mobility status, retrieve a model structure and parameters from the RMRF structure for the UE based on the model ID, and provide the model ID, the model structure, and the parameters to the UE.

Example 19 may include the RAN infrastructure of example 17 further comprising a radio access network data repository function (RDRF) structure coupled to the RMRF structure and the RMCF structure in the service based system architecture, the RDRF structure to store data to be utilized for training the AI/ML models, and a radio access network data coordination function (RDCF) structure coupled to the RMRF structure, the RMCF structure, and the RDRF structure in the service based system architecture, the RDCF structure to manage the data stored by the RDRF structure.

Example 20 may include the RAN infrastructure of example 19 further comprising a real-time artificial intelligence function (RTAIF) structure or a non real-time artificial intelligence function (NRTAIF) structure coupled to the RDRF structure and the RDCF structure, the RTAIF structure or the NRTAIF structure to determine a scenario corresponding to a UE based on a received RRC model request, determine a dataset identifier (ID) from the RDCF structure for the UE based on the scenario, retrieve a dataset from the RDRF structure based on the dataset ID, and train an AI/ML model for the UE utilizing the dataset.

Example 21 may include the RAN infrastructure of example 17, wherein the RMRF structure is merged with a model repository function (MRF) structure as part of a converged model repository function (CMRF) structure, and the RMCF structure is merged with a model coordination function (MCF) as part of a converged model coordination function (CMCF) structure.

Example 22 may include an apparatus comprising means to perform one or more elements of a method described in or related to any of examples 1-21, or any other method or process described herein.

Example 23 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 24 may include an apparatus comprising logic, modules, or circuitry to perform one or more elements of a method described in or related to any of examples 1-21, or any other method or process described herein.

Example 25 may include a method, technique, or process as described in or related to any of examples 1-21, or portions or parts thereof.

Example 26 may include an apparatus comprising: one or more processors and one or more computer-readable media comprising instructions that, when executed by the one or more processors, cause the one or more processors to perform the method, techniques, or process as described in or related to any of examples 1-21, or portions thereof.

Example 27 may include a signal as described in or related to any of examples 1-21, or portions or parts thereof.

Example 28 may include a datagram, information element, packet, frame, segment, PDU, or message as described in or related to any of examples 1-21, or portions or parts thereof, or otherwise described in the present disclosure.

Example 29 may include a signal encoded with data as described in or related to any of examples 1-21, or portions or parts thereof, or otherwise described in the present disclosure.

Example 30 may include a signal encoded with a datagram, IE, packet, frame, segment, PDU, or message as described in or related to any of examples 1-21, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Example 32 may include a computer program comprising instructions, wherein execution of the program by a processing element is to cause the processing element to carry out the method, techniques, or process as described in or related to any of examples 1-21, or portions thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a device comprising:
generating a radio resource control (RRC) model request that indicates a scenario, a channel, traffic, or a mobility status related to the device;
transmitting the RRC model request to a base station;
identifying an RRC model response received from the base station with an indication of an artificial intelligence/machine learning (AI/ML) model for the device; and
implementing the AI/ML model indicated by the RRC model response.

2. The method of claim 1, wherein the RRC model response includes a model identifier (ID), a model structure, or parameters that indicate the AI/ML model to be implemented by the device.

3. The method of claim 1, wherein the indication of the AI/ML model is supplied by a radio access network repository function (RMRF) included within a radio access network (RAN) infrastructure corresponding to the base station.

4. The method of claim 1, wherein the RRC model request indicates a scenario that comprises channel state information (CSI) compression related to the device or mobility related to the device.

5. The method of claim 1, wherein the RRC model request indicates traffic, and wherein the traffic comprises a traffic type related to the device and a traffic loading related to the device.

6. The method of claim 1, wherein the RRC model request indicates a mobility status, and wherein the mobility status comprises mobility speed related to the device or mobility parameters related to the device.

7. The method of claim 1, wherein the method further comprises:
generating an RRC model update request for requesting an updated AI/ML model for the device, the RRC model update request indicating a model identifier (ID) corresponding to the AI/ML model;
transmitting the RRC model update request to the base station;
identifying an RRC model update response received from the base station that indicates the updated AI/ML model for the device; and
implementing the updated AI/ML model indicated by the RRC model update response.

8. The method of claim 7, wherein the RRC model update request further indicates one or more trained model parameters related to the device.

9. One or more non-transitory, computer-readable media having instructions that, when executed by one or more processors, cause a base station to:
receive a radio resource control (RRC) model request from a device, the RRC model request indicating a scenario, a channel, traffic, or a mobility status related to the device;
select a function based on the scenario, the function being a real-time artificial intelligence function (RTAIF) or a non real-time artificial intelligence function (NRTAIF);
use the function to identify an artificial intelligence/machine learning (AI/ML) model for the device based on the channel, the traffic, or the mobility status indicated by the RRC model request;
generate an RRC model response that indicates a model identifier (ID) corresponding to the AI/ML model; and
transmit the RRC model response to the device.

10. The one or more non-transitory, computer-readable media of claim 9, wherein to identify the AI/ML model comprises to:
determine a plurality of AI/ML models stored by a radio access network model repository function (RMRF) or a model repository function (MRF); and
determine the AI/ML model from the plurality of AI/ML models based on the AI/ML model being determined to be most suitable for the device from the plurality of AI/ML models based on the channel, the traffic, or the mobility status.

11. The one or more non-transitory, computer-readable media of claim 10, wherein the plurality of AI/ML models are stored by the RMRF, and wherein the RMRF is located within a radio access network (RAN) infrastructure corresponding to the base station.

12. The one or more non-transitory, computer-readable media of claim 11, wherein the RAN infrastructure is implemented as a service based system architecture.

13. The one or more non-transitory, computer-readable media of claim 9, wherein the instructions, when executed by the one or more processors, further cause the base station to:
utilize the RTAIF or the NRTAIF to perform offline training of the AI/ML model.

14. The one or more non-transitory, computer-readable media of claim 13, wherein the instructions, when executed by the one or more processors, further cause the base station to:
determine, using the RTAIF or the NRTAIF, a dataset identifier (ID) from a radio access network data coordination function (RDCF) corresponding to a dataset suitable for the device based on the scenario; and
retrieve, utilizing the dataset ID, the dataset from a radio access network data repository function (RDRF), the dataset utilized for the offline training of the AI/ML model.

15. The one or more non-transitory, computer-readable media of claim 9, wherein the RRC model response further indicates a model structure for the AI/ML model and one or more model parameters for the AI/ML model.

16. The one or more non-transitory, computer-readable media of claim 9, wherein the instructions, when executed by the one or more processors, further cause the base station to:
receive a model update message from the device, the model update message indicating trained parameters and the model ID;
perform, using the NRTAIF, model fusion of the trained parameters with one or more sets of trained parameters provided by one or more neighboring radio access networks (RANs) to generate fused model parameters; and
provide the fused model parameters to the device.

17. A radio access network (RAN) infrastructure comprising:
a radio access network model repository function (RMRF) structure to store artificial intelligence/machine learning (AI/ML) models;
a radio access network model coordination function (RMCF) structure to manage the AI/ML models, the RMRF structure and the RMCF structure arranged in a service based system architecture and addressable via hypertext transfer protocol (HTTP) signaling; and
a base station coupled to the RMRF structure and the RMCF structure, the base station to communicate with one or more user equipments (UEs) to share the AI/ML models.

18. The RAN infrastructure of claim 17 further comprising:
a real-time artificial intelligence function (RTAIF) structure or a non real-time artificial intelligence function (NRTAIF) structure coupled to the RMRF structure and the RMCF structure, the RTAIF structure or the NRTAIF structure to:
determine a channel, traffic, and a mobility status corresponding to a device based on a received RRC model request;
determine a model identifier (ID) from the RMCF structure corresponding to an AI/ML model of the AI/ML models, the AI/ML model determined to be suitable for the device based on the channel, the traffic, and the mobility status;
retrieve a model structure and parameters from the RMRF structure for the device based on the model ID; and
provide the model ID, the model structure, and the parameters to the device.

19. The RAN infrastructure of claim 17 further comprising:
a radio access network data repository function (RDRF) structure coupled to the RMRF structure and the RMCF structure in the service based system architecture, the RDRF structure to store data to be utilized for training the AI/ML models; and
a radio access network data coordination function (RDCF) structure coupled to the RMRF structure, the RMCF structure, and the RDRF structure in the service based system architecture, the RDCF structure to manage the data stored by the RDRF structure.

20. The RAN infrastructure of claim 19 further comprising:
a real-time artificial intelligence function (RTAIF) structure or a non real-time artificial intelligence function (NRTAIF) structure coupled to the RDRF structure and the RDCF structure, the RTAIF structure or the NRTAIF structure to:
determine a scenario corresponding to a device based on a received RRC model request;
determine a dataset identifier (ID) from the RDCF structure for the device based on the scenario;
retrieve a dataset from the RDRF structure based on the dataset ID; and
train an AI/ML model for the device utilizing the dataset.
